(19) United States
(12) Patent Application Publication
(10) Pub. No.: US 2012/0163448 A1
(43) Pub. Date: Jun. 28, 2012

(54) CODING THE POSITION OF A LAST SIGNIFICANT COEFFICIENT OF A VIDEO BLOCK IN VIDEO CODING

(75) Inventors: Yunfei Zheng, Cupertino, CA (US); Muhammed Zeyd Coban, Carlsbad, CA (US); Joel Sole Rojals, La Jolla, CA (US); Marta Karczewicz, San Diego, CA (US)

(73) Assignee: QUALCOMM INCORPORATED, San Diego, CA (US)

(21) Appl. No.: 13/328,949

(22) Filed: Dec. 16, 2011

Related U.S. Application Data
(60) Provisional application No. 61/426,475, filed on Dec. 22, 2010.

(51) Int. Cl. H04N 7/26

(52) U.S. Cl. 375/240.02; 375/E07.027; 375/E07.138

(57) ABSTRACT

In one example, an apparatus is disclosed for coding coefficients associated with a block of video data during a video coding process, wherein the apparatus includes a video coder configured to code information that identifies a position of a last non-zero coefficient within the block according to a scanning order associated with the block, wherein to code the information, the video coder is configured to perform a context adaptive entropy coding process that includes the video coder applying a context model based on at least three contexts, wherein the at least three contexts include a size associated with the block, a position of a given one of the coefficients within the block according to the scanning order, and the scanning order.

This application claims the benefit of U.S. Provisional Application No. 61/426,475, filed Dec. 22, 2010, which is incorporated herein by reference in its entirety.

### TECHNICAL FIELD

This disclosure relates to video coding, and more particularly, to the coding of syntax information related to coefficients of a video block.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. The video devices may transmit, receive, encode, decode, and/or store digital video information more efficiently by implementing such video compression techniques.

Video compression techniques perform spatial (intra-picture) prediction and/or temporal (inter-picture) prediction to reduce or remove redundancy inherent in video sequences. For block-based video coding, a video slice (i.e., a video frame or a portion of a video frame) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy coding may be applied to achieve even more compression.

### SUMMARY

This disclosure describes techniques for coding coefficients associated with a block of video data during a video coding process, including techniques for coding information that identities a position of a last non-zero, or “significant” coefficient within the block according to a scanning order associated with the block, i.e., last significant coefficient position information for the block. The techniques of this disclosure may improve efficiency for coding of last significant coefficient position information for blocks of video data used to code the blocks by coding last significant coefficient position information for a particular block by performing a context adaptive entropy coding process, e.g., a context adaptive binary arithmetic coding (CABAC) process. The techniques may include applying a context model based on at least three contexts, wherein the at least three contexts include a size associated with the block, a position of a given one of the coefficients within the block according to the scanning order, and the scanning order. Applying the context model based on the at least three contexts when coding the last significant coefficient position information may result in accurate probability estimates, and may enable using a small number of bits to code the information when performing the context adaptive entropy coding process (e.g., CABAC process).

The techniques of this disclosure may be used with any context adaptive entropy coding methodology, including CABAC, probability interval partitioning entropy coding (PIPE), or another context adaptive entropy coding methodology. CABAC is described in this disclosure for purposes of illustration, but without limitation as to the techniques broadly described in this disclosure. Also, the techniques may be applied to coding of other types of data generally, e.g., in addition to video data.

Accordingly, the techniques of this disclosure may improve data compression insofar as the resulting context adaptive entropy coded last significant coefficient position information may be more compressed than similar information coded using other methods. In this manner, there may be a relative bit savings for a coded bitstream including the last significant coefficient position information for the block when using the techniques of this disclosure.

In one example, a method of coding coefficients associated with a block of video data during a video coding process includes coding information that identifies a position of a last non-zero coefficient within the block according to a scanning order associated with the block, wherein coding the information comprises performing a context adaptive entropy coding process that includes applying a context model based on at least three contexts, wherein the at least three contexts include a size associated with the block, a position of a given one of the coefficients within the block according to the scanning order, and the scanning order.

In another example, an apparatus for coding coefficients associated with a block of video data during a video coding process includes a video coder configured to code information that identifies a position of a last non-zero coefficient within the block according to a scanning order associated with the block, wherein to code the information, the video coder is configured to perform a context adaptive entropy coding process that includes the video coder applying a context model based on at least three contexts, wherein the at least three contexts include a size associated with the block, a position of a given one of the coefficients within the block according to the scanning order, and the scanning order.

In another example, a device for coding coefficients associated with a block of video data during a video coding process includes means for coding information that identifies a position of a last non-zero coefficient within the block according to a scanning order associated with the block, wherein the means for coding the information comprises means for performing a context adaptive entropy coding process that includes means for applying a context model based on at least three contexts, wherein the at least three contexts include a size associated with the block, a position of a given one of the coefficients within the block according to the scanning order, and the scanning order.

The techniques described in this disclosure may be implemented in hardware, software, firmware, or combinations thereof. If implemented in hardware, an apparatus may be realized as an integrated circuit, a processor, discrete logic, or any combination thereof. If implemented in software, the software may be executed in one or more processors, such as a microprocessor, application specific integrated circuit (ASIC), field programmable gate array (FPGA), or digital signal processor (DSP). The software that executes the techniques may be initially stored in a tangible computer-readable medium and loaded and executed in the processor.

Accordingly, this disclosure also contemplates a computer-readable medium comprising instructions that, when executed, cause a processor to code coefficients associated with a block of video data during a video coding process, wherein the instructions cause the processor to code information that identifies a position of a last non-zero coefficient within the block according to a scanning order associated with the block, wherein the instructions that cause the processor to code the information comprise instructions that cause the processor to perform a context adaptive entropy coding process that includes applying a context model based on at least three contexts, wherein the at least three contexts include a size associated with the block, a position of a given one of the coefficients within the block according to the scanning order, and the scanning order.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram that illustrates an example of a video encoding and decoding system that may implement techniques for coding information that identifies a position of a last significant coefficient within a block of video data according to a scanning order associated with the block, consistent with the techniques of this disclosure.

FIG. 2 is a block diagram that illustrates an example of a video encoder that may implement techniques for encoding information that identifies a position of a last significant coefficient within a block of video data according to a scanning order associated with the block, consistent with the techniques of this disclosure.

FIG. 3 is a block diagram that illustrates an example of a video decoder that may implement techniques for decoding encoded information that identifies a position of a last significant coefficient within a block of video data according to a scanning order associated with the block, consistent with the techniques of this disclosure.

FIGS. 4A-4C are conceptual diagrams that illustrate an example of a block of video data and corresponding significant coefficient position information and last significant coefficient position information.

FIGS. 5A-5C are conceptual diagrams that illustrate examples of blocks of video data scanned using a zig-zag scanning order, a horizontal scanning order, and a vertical scanning order.

FIGS. 6A-6D are conceptual diagrams that illustrate examples of blocks of video data and corresponding context indices used for applying a context model.

FIG. 7 is a flowchart that illustrates an example of a method of coding information that identifies a position of a last significant coefficient within a block of video data according to a scanning order associated with the block.

FIG. 8 is a flowchart that illustrates an example of a method of encoding information that identifies a position of a last significant coefficient within a block of video data according to a scanning order associated with the block.

FIG. 9 is a flowchart that illustrates an example of a method of decoding encoded information that identifies a position of a last significant coefficient within a block of video data according to a scanning order associated with the block.

### DETAILED DESCRIPTION

This disclosure describes techniques for coding coefficients associated with a block of video data during a video coding process. The techniques include coding information that identifies a position of a last non-zero, or “significant,” coefficient within the block according to a scanning order associated with the block, i.e. last significant coefficient position information for the block. The techniques of this disclosure may improve efficiency for coding last significant coefficient position information for blocks of video data used to code the blocks.

In this disclosure, the term “coding” refers to encoding that occurs at the encoder or decoding that occurs at the decoder. Similarly, the term “coder” refers to an encoder, a decoder, or a combined encoder/decoder (“CODEC”). The terms coder, encoder, decoder and CODEC all refer to specific machines designed for the coding (encoding and/or decoding) of video data consistent with this disclosure.

The techniques of this disclosure may exploit a correlation between a probability of a given coefficient associated with a block of video data being a last significant coefficient within the block according to a scanning order associated with the block, and the scanning order itself in particular, according to this disclosure, a probability of a given coefficient position within a block of video data containing a last significant coefficient for the block according to a scanning order associated with the block may vary depending on the scanning order. That is, different scanning orders may result in different statistics for the last significant coefficient position information for the block. As such, when coding the last significant coefficient position information for the block using the statistics, for example, when performing a context adaptive entropy coding process (e.g., a context adaptive binary arithmetic coding (CABAC) process) that includes applying a context model based on a context, choosing the statistics based at least in part on the scanning order associated with the block may result in using accurate statistics to code the information, which may enable coding the information more efficiently, e.g., using a smaller number of bits, than when using other methods. Accordingly, the techniques of this disclosure may exploit this correlation to efficiently code last significant coefficient position information for blocks of video data.

For example, a video coder may be configured to code information that identifies a position of a last significant coefficient within a block of video data according to a scanning order associated with the block, wherein to code the information, the video coder is configured to perform a context adaptive entropy coding process (e.g., a CABAC process) that includes applying a context model based on at least three contexts. According to the techniques of this disclosure, the at least three contexts used to apply the context model may include a size associated with the block, a position of a given one of the coefficients within the block according to the scanning order, and the scanning order.

The video coder may be configured as a video encoder to encode the last significant coefficient position information for the block. As one example, the video encoder may be configured to, for each of one or more coefficients associated with the block, starting with a first coefficient within the block according to the scanning order and ending with the last significant coefficient within the block according to the scanning order, and proceeding according to the scanning order, determine whether the coefficient is the last significant coefficient within the block according to the scanning order, and generate a last significant coefficient flag that indicates whether the coefficient is the last significant coefficient within the block according to the scanning order. The video encoder may be further configured to arrange the last significant coefficient flags for the one or more coefficients into a sequence based on the scanning order, and encode the sequence by performing the context adaptive entropy coding process. The video encoder may be still further configured to output the encoded sequence into a bitstream.

As described above, the video encoder configured to perform the context adaptive entropy coding process may include the video encoder being configured to apply a context model based on at least three contexts, wherein the at least three contexts include a size associated with the block, a position of a given one of the coefficients within the block according to the scanning order, and the scanning order. The at least three contexts may be collectively referred to as an “encoding context” for encoding the sequence. Accordingly, the video encoder may be configured to use the encoding context to apply the context model to encode the sequence. For example, the video encoder may be configured to, for each last significant coefficient flag of the sequence being encoded, apply the context model based at least in part on a size and the scanning order associated with the block, and based on a position within the block, according to the scanning order, corresponding to the last significant coefficient flag. The context model may provide probability estimates for the last significant coefficient flag used to encode the flag as part of performing the context adaptive entropy coding process. The probability estimates may indicate the probability of the coefficient corresponding to the last significant efficient flag being the last significant coefficient for the block.

Additionally, the video encoder may be configured to update the probability estimates for the context model based on the encoded last significant coefficient flag to reflect which last significant coefficient flag values (e.g., “0” or “1”) are more or less likely to occur given the encoding context. In particular, the video encoder may be configured to use the updated probability estimates for the context model for encoding subsequent blocks of video data using the same context model.

Because of the correlation described above, the video encoder configured to apply and update the context model using the encoding context (i.e., at least the scanning order associated with the block) may result in the context model containing accurate probability estimates, possibly resulting in efficient encoding, e.g., using a small number of bits to encode the last significant coefficient position information for the block. In this manner, the last significant coefficient position information for the block encoded by performing the context adaptive entropy coding process and using the encoding context may comprise fewer bits than similar information encoded using other methods, e.g., by performing a context adaptive entropy coding process and using a different context.

In another example, the video coder may be configured as a video decoder, e.g., to perform similar techniques to decode the last significant coefficient position information for the block. As one example, the video decoder may be configured to decode a sequence of last significant coefficient flags for one or more coefficients associated with the block, starting with a first coefficient within the block according to the scanning order and ending with the last significant coefficient within the block according to the scanning order, and proceeding according to the scanning order, wherein each of the last significant coefficient flags indicates whether the respective coefficient is the last significant coefficient within the block according to the scanning order, by performing the context adaptive entropy coding process. The video decoder may be further configured to, for each coefficient associated with the block, determine whether the coefficient is the last significant coefficient within the block according to the scanning order, based on the sequence. The video decoder may be still further configured to decode the block based on the determinations.

As described above with reference to the video encoder, the video decoder configured to perform the context adaptive entropy coding process may include the video decoder being configured to apply a context model based on at least three contexts, wherein the at least three contexts include a size associated with the block, a position of a given one of the coefficients within the block according to the scanning order, and the scanning order. In the case of the video decoder, the at least three contexts may be collectively referred to as a “decoding context” for decoding the sequence. The video decoder may be configured to use the decoding context to apply the context model to decode the sequence in a substantially similar manner as described above with reference to the video encoder. For example, the video decoder may be configured to, for each last significant coefficient flag of the sequence, apply the context model based on the size and the scanning order associated with the block (e.g., determined from other syntax information for the block), and based on a position within the block, according to the scanning order, corresponding to the last significant coefficient flag. In a similar manner as described above with reference to the video encoder, the applied context model may provide probability estimates for the last significant coefficient flag used to decode the flag as part of performing the context adaptive entropy coding process (e.g., a CABAC process). The probability estimates may indicate the probability of the coefficient corresponding to the last significant coefficient flag being the last significant coefficient for the block. Furthermore, the video decoder may be configured to use the probability estimates to decode other last significant coefficient flags of the sequence as part of performing the context adaptive entropy coding process. For example, the video decoder may be confiaured to use probability estimates for a given last significant coefficient flag of the sequence, provided by the context model based on the decoding context, to decode a subsequent last significant coefficient flag of the sequence, as described in greater detail below.

Additionally, as also described above, the video decoder may be configured to update the probability estimates for the context model based on the decoded last significant coefficient flag to reflect which last significant coefficient flag values (e.g., “0” or “1”) are more or less likely to occur given the decoding context. In particular, the video decoder may be configured to update the probability estimates for the context model to coordinate the context model with the context model used by the video encoder, as described above, and for decoding subsequent blocks of video data using same context model.

Once again, because of the correlation described above, the video decoder configured to apply and update the context model using the decoding context result in the context model containing accurate probability estimates, thereby enabling the video decoder to decode the information encoded by the video encoder using a substantially similar context model. As a result, better coding efficiency may be achieved relative to other techniques. In this manner, the last significant coefficient position information for the block, encoded and subsequently decoded by performing the context adaptive entropy coding process and using the encoding and decoding contexts as described above, may comprise fewer bits than similar information coded using other methods.

The techniques of this disclosure my be used with any context adaptive entropy coding methodology, including CABAC, probability interval partitioning entropy coding (PIPE), or another context adaptive entropy, coding methodology, CABAC is described in this disclosure for purposes of illustration, but without limitation as to the techniques broadly described in this disclosure. Also, the techniques may be applied to coding of other types of data generally, e.g., in addition to video data.

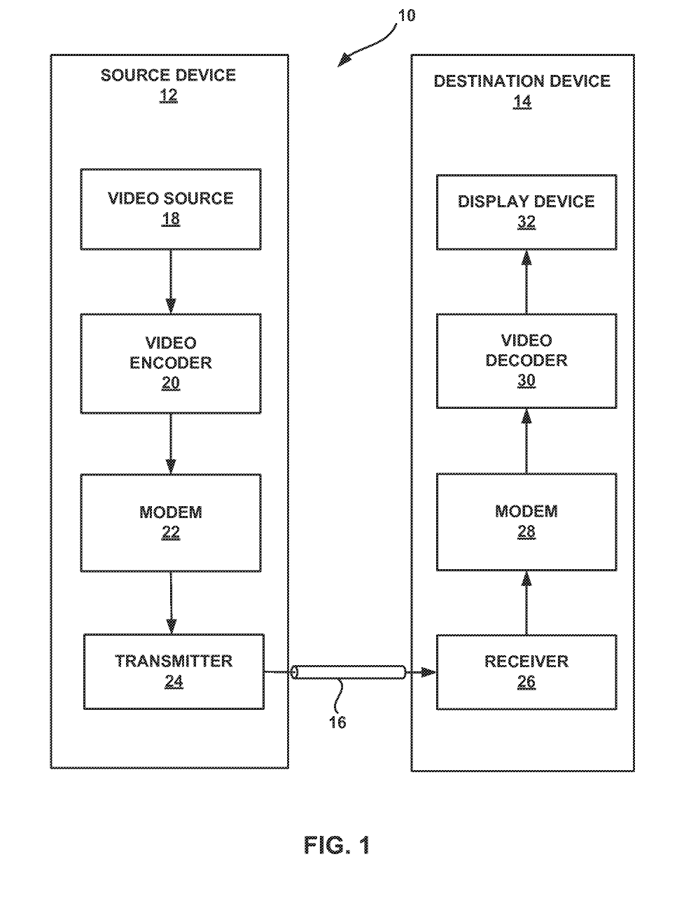

FIG. 1 is a block diagram that illustrates an example of a video encoding and decoding system 10 that may implement techniques for coding information that identifies a position of a last significant coefficient within a block of video data according to a scanning order associated with the block, consistent with the techniques of this disclosure. As shown in FIG. 1, system 10 includes a source device 12 that transmits encoded video to a destination device 14 via a communication channel 16. Source device 12 and destination device 14 may comprise any of a wide range of devices. In some cases, source device 12 and destination device 14 may comprise wireless communication devices, such as wireless handsets, so-called cellular or satellite radiotelephones, or any wireless devices that can communicate video information over a con channel 16, in which case communication channel 16 is wireless.

The techniques of this disclosure, however, which concern coding information that identifies a position of a last significant coefficient within a block of video data according to a scanning order associated with the block, are not necessarily limited to wireless applications or settings. These techniques may generally apply to any scenario where encoding or decoding is performed, including over-the-air television broadcasts, cable television transmissions, satellite television transmissions, streaming Internet video transmissions, encoded digital video that is encoded onto a storage medium or retrieved and decoded from a storage medium, or other scenarios. Accordingly, communication channel 16 is not required and the techniques of this disclosure may apply to settings where encoding is applied or where decoding is applied, e.g., without any, data communication between encoding and decoding devices.

In the example of FIG. 1, source device 12, includes a video source 18, video encoder 20, a modulator/demodulator (modem) 22 and a transmitter 24. Destination device 14 includes a receiver 26, a modem 28, a video decoder 30, and a display device 32. In accordance with this disclosure, video encoder 20 of source device 12 and/or video decoder 30 of destination device 14 may be configured to apply the techniques for coding information that identifies a position of a last significant coefficient within a block of video data according to a scanning order associated with the block. In other examples, a source device and a destination device may include other components or arrangements. For example, source device 12 may receive video data from an external video source 18, such as an external camera. Likewise, destination device 14 may interface with an external display device, rather than including an integrated display device.

The illustrated system 10 of FIG. 1 is merely one example. Techniques for coding information that identifies a position of a last significant coefficient within a block of video data according to a scanning order associated with the block may be performed by any digital video encoding and/or decoding device. Although generally the techniques of this disclosure are performed by a video encoding device, the techniques may also be performed by a video encoder/decoder, typically referred to as a “CODEC.” Moreover, the techniques of this disclosure may also be performed by a video preprocessor. Source device 12 and destination device 14 are merely examples of such coding devices in which source device 12 generates coded video data for transmission to destination device 14. In some examples, devices 12, 14 may operate in a substantially symmetrical manner such that each of devices 12, 14 includes video encoding and decoding components. Hence, system 10 may support one-way or two-way video transmission between video devices 12, 14, e.g., for video streaming, video playback, video broadcasting, or video telephony.

Video source 18 of source device 12 may include a video capture device, such as a video camera, a video archive containing previously captured video, and/or a video feed from a video content provider. As a further alternative, video source 18 may generate computer graphics-based data as the source video, or a combination of live video, archived video, and computer-generated video. In some cases, if video source 18 is a video camera, source device 12 and destination device 14 may form so-called camera phones or video phones. As mentioned above, however, the techniques described in this disclosure may be applicable to video coding in general, and may be applied to wireless and/or wired applications. In each case, the captured, pre-captured, or computer-generated video may be encoded by video encoder 20. The encoded video information may then be modulated by modem 22 according to a communication standard, and transmitted to destination device 14 via, transmitter 24. Modem 22 may include various mixers, filters, amplifiers or other components designed for signal modulation. Transmitter 24 may include circuits designed for transmitting data, including amplifiers, filters, and one or more antennas.

Receiver 26 of destination device 14 receives information over channel 16, and modem 28 demodulates the information. Again, the video encoding process described above may implement one or more of the techniques described herein to code information that identifies a position of a last significant coefficient within a block of video data according to a scanning order associated with the block. The information communicated over channel 16 may include syntax information defined by video encoder 20, which is also used by video decoder 30, that includes syntax elements that describe characteristics and/or processing of blocks of video data (e.g., macroblocks, or coding units), e.g., last significant coefficient position information for the blocks, and other information. Display device 32 displays the decoded video data to a user, and may comprise any of a variety of display devices such as a cathode ray tube (CRT), a liquid crystal display (LCD), a plasma display, an organic light emitting diode (OLED) display, or another type of display device.

In the example of FIG. 1, communication channel 16 may comprise any wireless or wired communication medium, such as a radio frequency (RE) spectrum or one or more physical transmission lines, or any combination of wireless and wired media. Communication channel 16 may form part of a packet-based network, such as a local area network, a wide-area network, or a global network such as the Internet, Communication channel 16 generally represents any suitable communication medium, or collection of different communication media, for transmitting video data from source device 12 to destination device 14, including any suitable combination of wired or wireless media. Communication channel 16 may include routers, switches, base stations, or any other equipment that may be useful to facilitate communication from source device 12 to destination device 14. In other examples, encoding or decoding devices may implement techniques of this disclosure without any communication between such devices. For example, an encoding device may encode and store an encoded bitstream consistent with the techniques of this disclosure. Alternatively, a decoding device may receive or retrieve an encoded bitstream, and decode the bitstream consistent with the techniques of this disclosure.

Video encoder 20 and video decoder 30 may operate according to a video compression standard, such as the ITU-T H.264 standard, alternatively referred to as MPEG-4, Part 10, Advanced Video Coding (AVC). The techniques of this disclosure, however, are not limited to any particular coding standard. Other examples include MPEG-2, ITU-T H.263, and the High Efficiency Video Coding (HEVC) standard presently under development. In general, the techniques of this disclosure are described with respect to HEVC, but it should be understood that these techniques may be used in conjunction with other video coding standards as well. Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

Video encoder 20 and video decoder 30 each may be implemented as any of a variety of suitable encoder and decoder circuitry, such as one or more microprocessors, digital signal processors (DSPs), application specific integrated circuits (ASICs), field programmable gate arrays (FPGAs), discrete logic, software, hardware, firmware or any combinations thereof. Each of video encoder 20 and video decoder 30 may be included in one or more encoders or decoders, either of which may be integrated as part of a combined encoder/decoder (CODEC) in a respective camera, computer, mobile device, subscriber device, broadcast device, set-top box, server, or the like.

A video sequence typically includes a series of video frames. A group of pictures (GOP) generally comprises a series of one or more video frames. A GOP may include syntax data in a header of the GOP, a header of one or more frames of the GOP, or elsewhere, that describes a number of frames included in the GOP. Each frame may include frame syntax data that describes an encoding mode for the respective frame. A video encoder, e.g., video encoder 20, typically operates on video blocks within individual video frames in order to encode the video data. According to the ITU-T H.264 standard, a video block may correspond to a macroblock or a partition of a macroblock. According to other standards, e.g., HEVC described in greater detail below, a video block my correspond to a coding unit (e.g., a largest coding unit), or a partition of a coding unit. The video blocks may have fixed or varying sizes, and may differ in size according to a specified coding standard. Each video frame may include a plurality of slices, i.e., portions of the video frame. Each slice may include a plurality of video blocks, which may be arranged into partitions, also referred to as sub-blocks.

Depending on the specified coding standard, video blocks may be partitioned into various “N×N” sub-block sizes, such as 16×16, 8×8, 4×4, 2×2, and so forth. In this disclosure, “N×N” and “N by N” may be used interchangeably to refer to the pixel dimensions of the block in terms of vertical and horizontal dimensions, e.g., 16×16 pixels or 16 by 16 pixels. In general, a 16×16 block will have sixteen pixels in a vertical direction (y=16) and sixteen pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N. As one example, in the ITU-T H.264 standard, blocks that are 16 by 16 pixels in size may be referred to as macroblocks, and blocks that are less than 16 by 16 pixels may be referred to as partitions of a 16 by 16 macroblock. In other standards, e.g., HEVC, blocks may be defined more generally with respect to their size, for example, as coding units and partitions thereof, each having a varying, rather than a fixed size.

Video blocks may comprise blocks of pixel data in the pixel domain, or blocks of transform coefficients in the transform domain, e.g., following application of a transform, such as a discrete cosine transform (DCT), integer transform, a wavelet transform, or a conceptually similar transform to residual data for a given video block, wherein the residual data represents pixel differences between video data for the block and predictive data generated for the block. In some cases, video blocks may comprise blocks of quantized transform coefficients in the transform domain, wherein, following application of a transform to residual data for a given video block, the resulting transform coefficients are also quantized.

Block partitioning serves an important purpose in block-based video coding techniques. Using smaller blocks to code video data may result in better prediction of the data for locations of a video frame that include high levels of detail, and may therefore reduce the resulting error (i.e., deviation of the prediction data from source video data), represented as residual data. While potentially reducing the residual data, such techniques may, however, require additional syntax information to indicate how the smaller blocks are partitioned relative to a video frame, and may result in an increased coded video bitrate. Accordingly, in some techniques, block partitioning may depend on balancing the desirable reduction in residual data against the resulting increase in bitrate of the coded video data due to the additional syntax information.

In general, blocks and the various partitions thereof (i.e., sub-blocks) may be considered video blocks. In addition, a slice may be considered to be a plurality of video blocks (e.g., macroblocks, or coding units), and/or sub-blocks (partitions of macroblocks, or sub-coding units). Each slice may be an independently decodable unit of a video frame. Alternatively, frames themselves may be decodable units, or other portions of a frame may be defined as decodable units. Furthermore, a GOP, also referred to as a sequence, may be defined as a decodable unit.

Efforts are currently in progress to develop a new video coding standard, currently referred to as High Efficiency Video Coding (HEVC). The emerging HEVC standard may also be referred to as H.265. The standardization efforts are based on a model of a video coding device referred to as the HEVC Test Model (HM). The HM presumes several capabilities of video coding devices over devices according to, e.g., ITU-T H.264/AVC. For example, whereas H.264 provides nine intra-prediction encoding modes, HM provides as many as thirty-five intra-prediction encoding modes, e.g., based on the size of a block being intra-prediction coded.

HM refers to a block of video data as a coding unit (CU). A CU may refer to a rectangular image region that serves as a basic unit to which various coding tools are applied for compression. In H.264, it may also be called a macroblock. Syntax data within a bitstream may define largest coding unit (LCU), which is a largest CU in terms of the number of pixels. In general, a CU has a similar purpose to a macroblock of H.264, except that a CU does not have a size distinction. Thus, a CU may be partitioned, or “split” into sub-CUs.

An LCU my be associated with a quadtree data structure that indicates how the LCU is partitioned. In general, a quadtree data structure includes one node per CU of LCU, where a root node corresponds to the LCU, and other nodes correspond to sub-CUs of the LCU. If a given CU is split into four sub-CUs, the node in the quadtree corresponding to the split CU includes four child nodes, each of which corresponds to one of the sub-CUs. Each node of the quadtree data structure may provide syntax information for the corresponding CU. For example, a node in the quadtree may include a split flag for the CU, indicating whether the CU corresponding to the node is split into four sub-CUs. Syntax information for a given CU may be defined recursively, and may depend on whether the CU is split into sub-CUs.

A CU that is not split (i.e., a CU corresponding a terminal, or “leaf” node in a given quadtree) may include one or more prediction units (PUs). In general, a PU represents all or a portion of the corresponding CU, and includes data for retrieving a reference sample for the PU for purposes of performing prediction for the CU. For example, when the CU is intra-mode encoded, the PU may include data describing an intra-prediction mode for the PU. As another example, when the CU is inter-mode encoded, the PU may include data defining a motion vector for the PU. The data defining the motion vector may describe, for example, a horizontal component of the motion vector, a vertical component of the motion vector, a resolution for the motion vector (e.g., one-quarter pixel precision or one-eighth pixel precision), a reference frame to which the motion vector points, and/or a reference list (e.g., list 0 or list 1) for the motion vector. Data for the CU defining the one or more PUs of the CU may also describe, for example, partitioning of the CU into the one or more PUs. Partitioning modes may differ between whether the CU is uncoded, intra-prediction mode encoded, or inter-prediction mode encoded.

A CU having one or more PUs may also include one or more transform units (TUs). Following prediction for a CU using one or more PUs, as described above, a video encoder may calculate one or more residual blocks for the respective portions of the CU corresponding to the one of more PUs. The residual blocks may represent a pixel difference between the video data for the CU and the predicted data for the one or more PUs. A set of residual values may be transformed, scanned, and quantized to define a set of quantized transform coefficients. A TU may define a partition data structure that indicates partition information for the transform coefficients that is substantially similar to the quadtree data structure described above with reference to a CU. A TU is not necessarily limited to the size of a PU. Thus, TUs may be larger or smaller than corresponding PUs for the same CU. In some examples, the maximum size of a TU may correspond to the size of the corresponding CU. In one example, residual samples corresponding to a GU may be subdivided into smaller units using a quadtree structure known as “residual quad tree” (RQT). In this case, the leaf nodes of the RQT may be referred as the TUs, for which the corresponding residual samples may be transformed and quantized.

Following intra-predictive or inter-predictive encoding to produce predictive data and residual data, and following any transforms (such as the 4×1 or 8×8 integer transform used in H.264/AVC or a discrete cosine transform DCT) to produce transform coefficients, quantization of transform coefficients may be performed. Quantization generally refers to a process in which transform coefficients are quantized to possibly reduce the amount of data used to represent the coefficients. The quantization process may reduce the bit depth associated with some or all of the coefficients. For example, an n-bit value may be rounded down to an m-bit value during quantization, where n is greater than M.

Following quantization, entropy coding of the quantized data (i.e., quantized transform coefficients) may be performed. The entropy coding may conform to the techniques of this disclosure with respect to coding information that identifies a position of a last significant coefficient within a block of video data according to a scanning order associated with the block, and may also use other entropy coding techniques, such as context adaptive variable length coding (CAVLC), CABAC, PIPE, or another entropy coding methodology. For example, coefficient values, represented as magnitudes and corresponding signs (e.g., “+1,” “−1”) for the quantized transform coefficients may be encoded using the entropy coding techniques.

It should be noted that the prediction, transform, and quantization described above may be performed for any block of video data, e.g., to a PU and/or TV of a CU, or to a macroblock, depending on the specified coding standard. Accordingly, the techniques of this disclosure, relating to coding information that identifies a position of a last significant coefficient within a block of video data according to a scanning order associated with the block, may apply to any block of video data, e.g., to any block of quantized transform coefficients, including a macroblock, or a TU of a CU. Furthermore, a block of video data (e.g., a macroblock, or a TU of a CU) may include each of a luminance component (Y), a first chrominance component (U), and a second chrominance component (V) of the corresponding video data. As such, the techniques of this disclosure may be performed for each of the Y, U, and V components of a given block of video data.

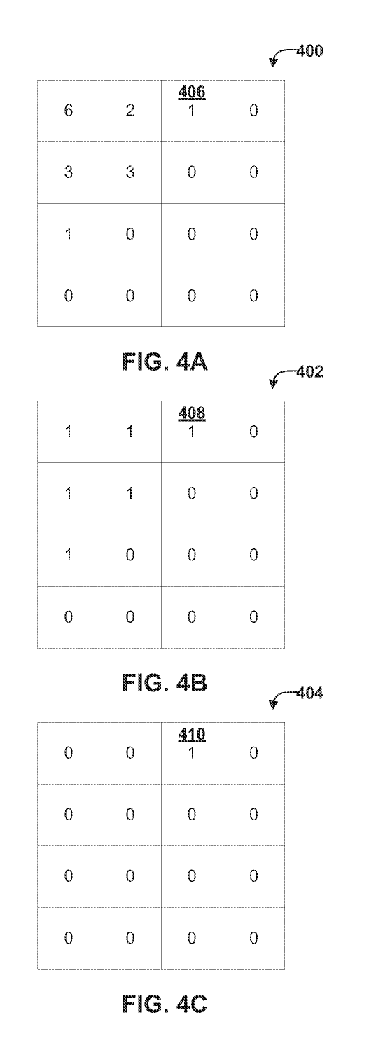

In order to encode blocks of video data as described above, information regarding position of significant coefficients within a given block may also be generated and encoded. Subsequently, the values of the significant coefficients may be encoded, as described above. In H.264/AVC and the emerging HEVC standard, when using a context adaptive entropy coding process, CABAC process, the position of significant coefficients within a block of video data may be encoded prior to encoding the values (i.e., “levels”) of the significant coefficients. The process of encoding the position of all of the significant coefficients within the block may be referred to as significance map (SM) encoding. FIGS. 4A-4C, described in greater detail below, are conceptual diagrams that illustrate an example of a 4×4 block of quantized transform coefficients and corresponding SM data.

A typical SM encoding procedure may be described as follows. For a given block of video data, an SM may be encoded only if there is at least one significant coefficient within the block. Presence of significant coefficients within a given block of video data may be indicated in a coded block pattern (e.g., using syntax element “coded_block_pattern,” or CBP), which is a binary value coded for a set of blocks (such as luminance and chrominance blocks) associated with an area of pixels in the video data. Each bit in the CBP is referred to as a coded block flag (e.g., corresponding to syntax element “coded_block_flag”) and used to indicate whether there is at least one significant coefficient within its corresponding block. In other words, a coded block flag is a one-bit symbol indicating whether there are any significant coefficients inside a single block of transform coefficients, and a CBP is a set of coded block flags for a set of related video data blocks.

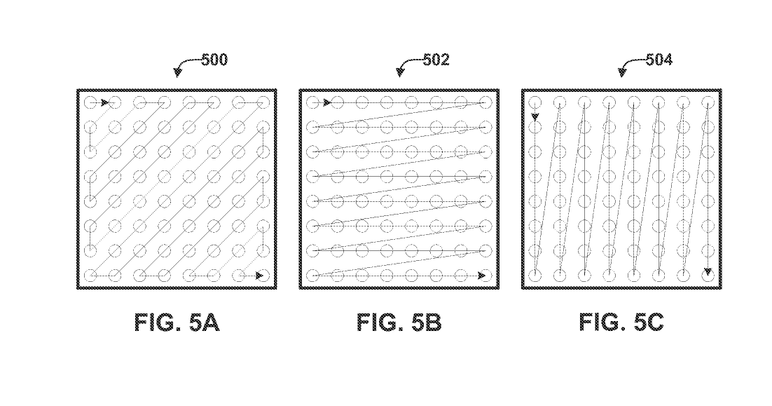

If a coded block flag indicates that no significant coefficients are present within the corresponding block (e.g., the flag equals “0”), no further information may be encoded for the block. However, if a coded block flag indicates that at least one significant coefficient exists within the corresponding block (e.g., the flag equals “1”), an SM may be encoded for the block by following a coefficient scanning order associated with the block. The scanning order may define the order in which the significance of each coefficient within the block is encoded as part of the SM encoding. In other words, scanning may serialize the two-dimensional block of coefficients to a one-dimensional representation to determine the significance of the coefficients. Different scanning orders (e.g., zigzag, horizontal, and vertical) my be used. FIGS. 5A-5C, also described in greater detail below, illustrate examples of some of the various scanning orders that may be used for 8×8 blocks of video data. The techniques of this disclose, however, may also apply with respect to a wide variety of other scanning orders, including a diagonal scanning order, scanning orders that are combinations of zigzag, horizontal, vertical, and/or diagonal scanning orders, as well as scanning orders that are partially zigzag, partially horizontal, partially vertical, and/or partially diagonal. In addition, the techniques of this disclosure may also consider a scanning order that is itself adaptive based on statistics associated with previously coded blocks of video data (e.g., blocks having the same block size or coding mode as the current block being coded). For example, an adaptive scanning order could be the scanning order associated with the block, in some cases.

Given a coded block flag that indicates that at least one significant coefficient exists within a given block, and a scanning order for the block, an SM for the block may be encoded as follows. The two-dimensional block of quantized transform coefficients may first be mapped into a one-dimensional array using the scanning order. For each coefficient in the array, following the scanning order, a one-bit significant coefficient flag (e.g., corresponding to syntax element “significant_coeff_flag”) may be encoded. That is, each position in the array may be assigned a binary value, which may be set to “1” if the corresponding coefficient is significant, and set to “0” if it is non-significant (i.e., zero). If a given significant coefficient flag equals “1,” indicating that the corresponding coefficient is significant, an additional one-bit last significant coefficient flag (e.g., corresponding to syntax element “last_significant_coeff_flag”) may also be encoded, which may indicate whether the corresponding coefficient is the last significant coefficient within the array (i.e., within the block given the scanning order). Specifically, each last significant coefficient flag may be set to “1” if the corresponding coefficient is the last significant coefficient within the array, and set to “0” otherwise. If the last array position is reached in this manner, and the SM encoding process was not terminated by a last significant coefficient flag equal to “1,” then the last coefficient in the array (and thereby the block given the scanning order) may be inferred to be significant, and no last significant coefficient flag may be encoded for the last array position.

FIGS. 4B-4C are conceptual diagrams that illustrate examples of sets of significant coefficient flags and last significant coefficient flags, respectively, corresponding to SM data for the block depicted in FIG. 4A, presented in map, rather than array form. It should be noted that significant coefficient flags and last significant coefficient flags, as described above, may be set to different values (e.g., a significant coefficient flag may be set to “0” if the corresponding coefficient is significant, and “1” if it is non-significant, and a last significant coefficient flag may be set to “0” if the corresponding coefficient is the last significant coefficient, and “1” if it is not the last significant coefficient) in other examples.

After the SM is encoded, as described above, the value of each significant coefficient (i.e., each significant coefficient's magnitude and sign, e.g., indicated by syntax elements “coeff_abs_level_minus1” and “coeff_sign_flag,” respectively) in the block may also be encoded.

According to some coding standards, when coding syntax elements, such as e.g., significant_coeff_flag and last_significant_coeff_flag, using a context adaptive entropy coding process (e.g., a CABAC process), a context model may be applied to code the syntax elements using a context index (ctx) value, which serves as an indicator of a particular probability estimate of the applied context model to be used. Context model application for last significant coefficient flags (i.e. a set of last significant coefficient flags) for a given block consistent with the ITU H.264/AVC standard depends on the corresponding coefficient position within the block given a scanning order associated with the block and the block type. Additional context model application considerations may include block size, e.g., sometimes included in block type. The block size may refer to the size of the CU, the size of the PU, or the size of the TU with respect to the HEVC standard. For every last significant coefficient flag for the block arranged into a sequence according to the scanning order, as previously described, a context model is applied based on the above considerations, or “coding contexts,” using a corresponding ctx value for the flag. As described above, the applied context model may provide probability estimates for the last significant coefficient flag used to code the flag as part of performing the context adaptive entropy coding process (e.g., a CABAC process), indicating the probability of the coefficient corresponding to the flag being the last significant coefficient for the block. As also described above, for the applied context model, the probability estimates may be updated based on the coded last significant coefficient flag to reflect which flag values (e.g., “0” or “1”) are more or less likely to occur given the coding contexts. In particular, the updated probability estimates for the context model be used for coding subsequent blocks of video data using the same context model.

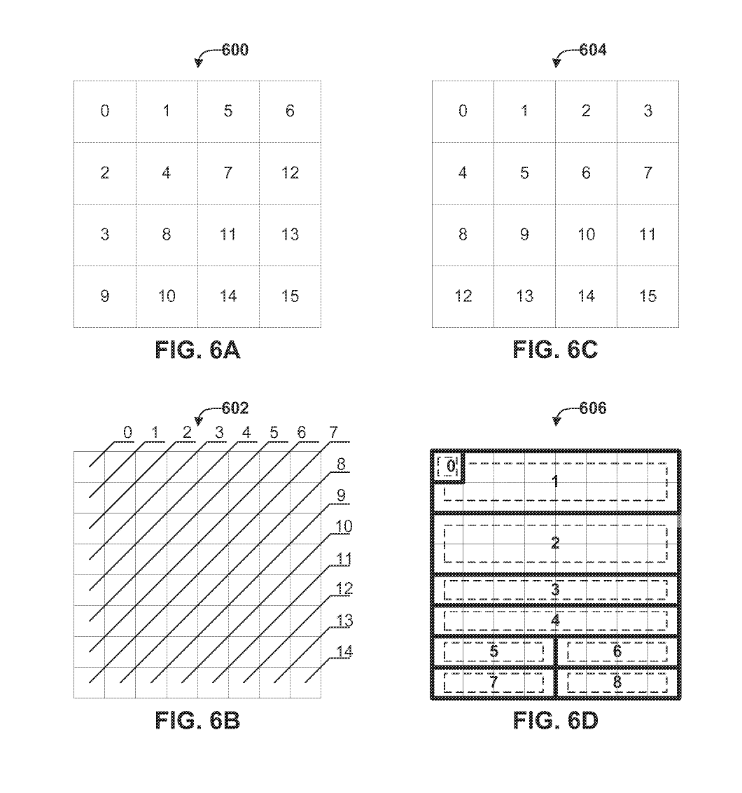

FIGS. 6A-6D, also described in greater detail below, are conceptual diagrams that illustrate examples of how ctx values for last significant coefficient flags for a block of video data may be derived using a size associated with the block, and corresponding coefficient positions within the block according to a scanning order associated with the block. FIGS. 6A and 6C show 4×4 blocks, wherein for each block, the derived ctx values are unique for each block position within the block according to the scanning order associated with the block. FIG. 6B shows an 8×8 block, where the block positions located diagonally with respect to one another, as depicted in FIG. 6B, share a common ctx value. In this example, ranges of block positions according to the zig-zag scanning order share a common ctx value. Similarly, FIG. 6D shows another 8×8 block, where the block positions located in a particular rectangular region of the block defined according to a horizontal scanning order share a common ctx value. Once again, in this example, ranges of block positions according to the horizontal scanning order share a common ctx value.

In the examples of FIGS. 6A-6D, in instances where a given block is larger than an 8×8 block, a position within the block may be mapped to a corresponding position within an 8×8 block, as described in greater detail below. Subsequently, any of the ctx value derivation methods for an 8×8 block previously described can be used to determine a ctx value for the position within the larger block. In other examples, various other techniques may be used to derive ctx values for last significant coefficient flags for a block, each defined by a relationship between a size of the block, and corresponding coefficient positions within the block according to a scanning order associated with the block.

Once encoded by performing a context adaptive entropy coding process (e.g., a CABAC process), last significant coefficient position information for a block of video data may be signaled by an encoder to a decoder to be used to decode corresponding encoded quantized transform coefficients (i.e., coefficient values) for the block. Last significant coefficient position information may consume a high percentage of the overall compressed video bitrate if coded inefficiently (i.e., using context models containing inaccurate or incomplete probability estimates). Therefore, context model design and application for coding last significant coefficient position information for a block of video data by performing a context adaptive entropy coding process (e.g., a CABAC process) is very important to achieving efficient coding and effective overall video data compression.

Accordingly, this disclosure provides techniques for efficiently coding last significant coefficient position information for blocks of vide data. In particular, when coding last significant coefficient position information for a block of video data by performing a context adaptive entropy coding process (e.g., a CABAC process) that includes applying a context model, this disclosure provides techniques for applying the context model based on at least three contexts, wherein the at least three contexts include, a size associated with the block, a position of a given one of the coefficients within the block according to the scanning order, and the scanning order.

Again, the techniques of this disclosure may exploit a correlation between probability of a given coefficient associated with a block of video data being a last significant coefficient within the block according to a scanning order associated with the block, and the scanning order itself. Referring back to FIGS. 4A-4C, as shown in FIGS. 4A-4C, last significant coefficient position information for quantized transform coefficients of block 400 of FIG. 4A, indicated by last significant coefficient flags of block 404 of FIG. 4C, will vary depending on which scanning order, e.g., as shown in FIGS. 5A-5C, is used to scan the quantized transform coefficients of block 400, as previously described. That is, different scanning orders may result in different statistics for the last significant coefficient position information for block 400. According to the techniques of this disclosure, because of the correlation described above, when coding the last significant coefficient position information for a block of video data by performing a context adaptive entropy coding process (e.g., a CABAC process) that includes applying a context model, using at least a size associated with the block, a position of a given one of the coefficients within the block according to the scanning order, and the scanning order, as contexts for applying the context model, and updating the applied context model using the coded information, may result in the context model containing accurate probability estimates for coding the information, potentially resulting in efficient coding.

As one example, video encoder 20 of source device 12 may be configured to encode certain blocks of video data (e.g., one or more macroblocks, or TUs of a CU). In accordance with the techniques of this disclosure, as one example, video encoder 20 may be configured to code information that identifies a position of a last significant coefficient within a block of video data according to a scanning order associated with the block, wherein to code the information, video encoder 20 is configured to perform a context adaptive entropy coding process that includes video encoder 20 applying a context model based on at least three contexts, wherein the at least three contexts include a size associated with the block, a position of a given one of the coefficients within the block according to the scanning order, and the scanning order.

For example, video encoder 20 may be configured to, for each of one or more coefficients associated with the block, starting with a first coefficient within the block according to the scanning order and ending with the last significant coefficient within the block according to the scanning order, and proceeding according to the scanning order, determine whether the coefficient is the last significant coefficient within the block according to the scanning order, and generate a last significant coefficient flag that indicates whether the coefficient is the last significant coefficient within the block according to the scanning order. Video encoder 20 may be further configured to arrange the last significant coefficient flags for the one or more coefficients into a sequence based on the scanning order, and encode the sequence by performing the context adaptive entropy coding process.

As also described above, video encoder 20 may be configured to determine an encoding context used to apply the context model to encode the sequence when performing the context adaptive entropy coding process. For example, as described above, the encoding context may include various characteristics of the block and of the particular last significant coefficient flag being encoded, such as, for example, a size associated with the block, a position of a coefficient corresponding to the flag within the block according to the scanning order, and the scanning order itself.

Video encoder 20 may be configured to use the encoding context to apply the context model to encode the sequence by performing the context adaptive entropy coding process (e.g., a CABAC process). As a result, the sequence may comprise a context adaptive entropy (e.g., CABAC)-encoded value that indicates the position of the last significant coefficient within the block according to the scanning order. For example, video encoder 20 may be configured to, for each last significant coefficient flag of the sequence being encoded, apply the context model based on the size and the scanning order associated with the block, and based on a position within the block, according to the scanning order, corresponding to the last significant coefficient flag. The context model may provide probability estimates for the last significant coefficient flag used to encode the flag as part of performing the context adaptive entropy coding process. The probability estimates may indicate the probability of the coefficient corresponding to the last significant coefficient flag being the last significant coefficient for the block.

Moreover, video encoder 20 may be configured to update the context model based on the encoded last significant coefficient flags of the sequence to reflect which flag values are more or less likely to occur for the determined encoding context. Accordingly, video encoder 20 may be configured to encode the block to include the encoded sequence indicating the last significant coefficient position information for the block. For example, video encoder 20 may be configured to output the encoded sequence into a bitstream. Because using the techniques described above may result in the encoded sequence comprising fewer bits than similar information encoded using other methods, there may be a relative bit savings for a coded bitstream including the encoded sequence when using the techniques of this disclosure.

As another example, video decoder 30 of destination device 14 may be configured to receive encoded video data (e.g., one or more macroblocks, or TUs of a CU) from video encoder 20, e.g., from modem 28 and receiver 26. In accordance with the techniques of this disclosure, as one example, video decoder 30 may be configured to code information that identifies a position of a last significant coefficient within a block of video data according to a scanning order associated with the block, wherein to code the information, video decoder 30 is configured to perform a context adaptive entropy coding process (e.g., a CABAC process) that includes video decoder 30 applying a context model based on at least three contexts, wherein the at least three contexts include a size associated with the block, a position of a given one of the coefficients within the block according to the scanning order, and the scanning order.

For example, video decoder 30 may be configured to decode a sequence of last significant coefficient flags for one or more coefficients associated with the block, starting with a first coefficient within the block according to the scanning order and ending with the last significant coefficient within the block according to the scanning order, and proceeding according to the scanning order, wherein each of the last significant coefficient flags indicates whether the respective coefficient is the last significant coefficient within the block according to the scanning order, by performing the context adaptive entropy coding process. Video decoder 30 may be further configured to, for each coefficient associated with the block, determine whether the coefficient is the last significant coefficient within the block according to the scanning order, based on the sequence.

As described above with reference to video encoder 20, the encoded sequence may comprise a context adaptive entropy (e.g., CABAC)-encoded value. As such, video decoder 30 may be further configured to determine a decoding context used to apply the context model to decode the sequence when performing the context adaptive entropy coding process. Video decoder 30 may be configured to determine the decoding context in a manner substantially similar to that of video encoder 20, as previously described. For example, the decoding context may include various characteristics of the block and of the particular last significant coefficient flag being decoded, such as, for example, a size associated with the block, a position of a coefficient corresponding to the fiag within the block according to the scanning order, and the scanning order itself. Video decoder 30 may be still further configured to decode the block based on the determinations, as described below.

Video decoder 30 may be configured to use the decoding context to apply the context model to decode the sequence by performing the context adaptive entropy coding process. For example, video decoder 30 may be configured to, for each last significant coefficient flag of the sequence, apply the context model based on the size and the scanning order associated with the block (e.g., determined from other syntax information for the block), and based on a position within the block, according to the scanning order, corresponding to the last significant coefficient flag. The context model may provide probability estimates for the last significant coefficient flag used to decode the flag as part of performing the context adaptive entropy coding process. The probability estimates may indicate the probability of the coefficient corresponding to the last significant coefficient flag being the last significant coefficient for the block. As also described above, video decoder 30 may be configured to use the probability estimates to decode other last significant coefficient flags of the sequence as part of performing the context adaptive entropy coding process.

Moreover, video decoder 30 may be configured to update the context model based on the decoded last significant coefficient flags of the sequence to reflect which flag values are more or less likely to occur for the determined decoding context, e.g., to coordinate the context model with the context model used by video encoder 20 to encode the flags. In other words, video decoder 30 may be configured to update the context model based on statistics compiled over the course of decoding a particular video sequence.

Finally, video decoder 30 may be configured to decode the block based on the determined last significant coefficient position information. Once again, because using the techniques described above may result in the encoded sequence comprising fewer bits than similar information coded using other methods, there may be a relative bit savings for a coded bitstream including the encoded sequence when using the techniques of this disclosure.

Video encoder 20 and video decoder 30 each may be implemented as any of a variety of suitable encoder or decoder circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 20 and video decoder 30 may be included in one or more encoders or decoders, either of which may be integrated as part of a combined video encoder/decoder (CODEC). An apparatus including video encoder 20 and/or video decoder 30 may comprise an integrated circuit, a microprocessor, and/or a wireless communication device, such as a cellular telephone.

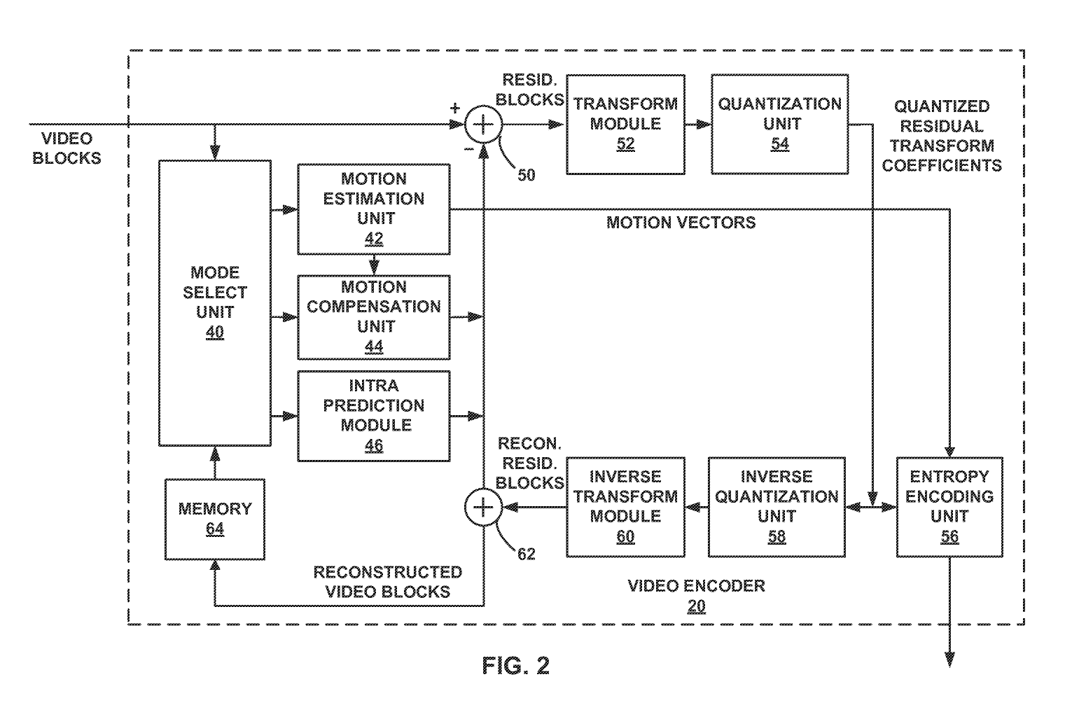

FIG. 2 is a block diagram that illustrates an example of a video encoder 20 that may implement techniques for encoding information that identifies a position of a last significant coefficient within a block of video data according to a scanning order associated with the block, consistent with the techniques of this disclosure. Video encoder 20 may perform intra- and inter-coding of blocks within video frames, including macroblocks, CUs, and partitions or sub-partitions thereof. Intra-coding relies on spatial prediction to reduce or remove spatial redundancy in video within a given video frame. Inter-coding relies on temporal prediction to reduce or remove temporal redundancy in video within adjacent frames of a video sequence. Intra-mode (I-mode) may refer to any of several spatial based compression modes, and inter-modes, such as uni-directional prediction (P-mode) or bi-directional prediction (B-mode), may refer to any of several temporal-based compression modes.

As shown in FIG. 2, video encoder 20 receives a current block of video data within a video frame to be encoded. In the example of FIG. 2, video encoder 20 includes motion compensation unit 44, motion estimation unit 42, memory 64, summer 50, transform module 52, quantization unit 54, and entropy encoding unit 56. For video block reconstruction, video encoder 20 also includes inverse quantization unit 58, inverse transform module 60, and summer 62. A deblocking filter (not shown in FIG. 2) may also be included to filter block boundaries to remove blockiness artifacts from reconstructed video. If desired, the deblocking filter would typically filter the output of summer 62.

During the encoding process, video encoder 20 receives a video frame or slice to be coded. The frame or slice may be divided into multiple video blocks. Motion estimation unit 42 and motion compensation unit 44 may perform inter-predictive coding of a given received video block relative to one or more blocks in one or more reference frames to provide temporal compression. Intra-prediction module 46 may perform intra-predictive coding of a given received video block relative to one or more neighboring blocks in the same frame or slice as the block to be coded to provide spatial compression.

Mode select unit 40 may select one of the coding modes, i.e., one mode or multiple intra or inter coding modes, based on coding results (e.g., resulting coding rate and level of distortion), and based on a frame or slice type for the frame or slice including the given received block being coded, and provide the resulting intra- or inter-coded block to summer 50 to generate residual block data and to summer 62 to reconstruct the encoded block for use in a reference frame or reference slice. In general, intra-prediction involves predicting a current block relative to neighboring, previously coded blocks, while inter-prediction involves motion estimation and motion compensation to temporally predict the current block.

Motion estimation unit 42 and motion compensation unit 44 represent the inter-prediction elements of video encoder 20. Motion estimation unit 42 and motion compensation unit 44 may be highly integrated, but are illustrated separately for conceptual purposes. Motion estimation is the process of generating motion vectors, which estimate motion for video blocks. A motion vector, for example, may indicate the displacement of a predictive block within a predictive reference frame (or other coded unit) relative to the current block being coded within the current frame (or other coded unit). A predictive block is a block that is found to closely match the block to be coded, in terms of pixel difference, which may be determined by sum of absolute difference (SAD), sum of square difference (SSD), or other difference metrics. A motion vector may also indicate displacement of a partition of a block. Motion compensation may involve fetching or generating the predictive block based on the motion vector determined by motion estimation. Again, motion estimation unit 42 and motion compensation unit 44 may be functionally integrated, in some examples.

Motion estimation unit 42 may calculate a motion vector for a video block of an inter-coded frame by comparing the video block to video blocks of a reference frame in memory 64. Motion compensation unit 44 may also interpolate sub-integer pixels of the reference frame, e.g., an I-frame or a P-frame, for the purposes of this comparison. The ITU H.264 standard, as an example, describes two lists: list 0, which includes reference frames having a display order earlier than a current frame being encoded, and list 1, which includes reference frames having a display order later than the current frame being encoded. Therefore, data stored in memory 64 may be organized according to these lists.

Motion estimation unit 42 may compare blocks of one or more reference frames from memory 64 to a block to be encoded of a current frame, a P-frame or a B-frame. When the reference frames in memory 64 include values for sub-integer pixels, a motion vector calculated by motion estimation unit 42 may refer to a sub-integer pixel location of a reference frame. Motion estimation unit 42 and/or motion compensation unit 44 may also be configured to calculate values for sub-integer pixel positions of reference frames stored in memory 64 if no values for sub-integer pixel positions are stored in memory 64. Motion estimation unit 42 may send the calculated motion vector to entropy encoding unit 56 and motion compensation unit 44. The reference frame block identified by a motion vector may be referred to as an inter-predictive block, or, more generally, a predictive block. Motion compensation unit 44 may calculate prediction data based on the predictive block.

Intra-prediction module 46 may intra-predict a current block, as an alternative to the inter-prediction performed by motion estimation unit 42 and motion compensation unit 44, as described above. In particular, intra-prediction module 46 may determine an intra-prediction mode to use to encode a current block. In some examples, intra-prediction module 46 may encode a current block using various intra-prediction modes, e.g., during separate encoding passes, and intra-prediction module 46 (or mode select unit 40, in some examples) may select an appropriate intra-prediction mode to use from the tested modes. For example, intra-prediction module 46 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bit rate (that is, a number of bits) used to produce the encoded block. Intra-prediction module 46 may calculate ratios from the distortions and rates for the various encoded blocks to determine which intra-prediction mode exhibits the best rate-distortion value for the block.

After predicting a current block, e.g., using intra-prediction or inter-prediction, video encoder 20 may form a residual video block by subtracting the prediction data calculated by motion compensation unit 44 or intra-prediction module 46 from the original video block being coded, Summer 50 represents the component or components that may perform this subtraction operation. Transform module 52 may apply a transform, such as a discrete cosine transform (DCT) or a conceptually similar transform, to the residual block, producing a video block comprising residual transform coefficient values. Transform module 52 may perform other transforms, such as those defined by the H.264 standard, which are conceptually similar to DCT. Wavelet transforms, integer transforms, sub-band transforms or other types of transforms could also be used. In any case, transform module 52 may apply the transform to the residual block, producing a block of residual transform coefficients. The transform may convert the residual information from a pixel domain to a transform domain, such as a frequency domain. Quantization unit 54 may quantize the residual transform coefficients to further reduce bit rate. The quantization process may reduce the bit depth associated with some or all of the coefficients. The degree of quantization may be modified by adjusting a quantization parameter.

Following quantization, entropy encoding unit 56 may entropy encode the quantized transform coefficients using the techniques of this disclosure for coding information that identities a position of a last significant coefficient within a block of video data according to a scanning order associated with the block. For other types of syntax elements, however, entropy encoding unit 56 may perform other entropy coding techniques, which may include CABAC, PIPE, or another entropy coding technique. Following the entropy coding by entropy encoding unit 56, the encoded video may be transmitted to another device or archived for later transmission or retrieval.

In some cases, entropy encoding unit 56 or another unit of video encoder 20 may be configured to perform other coding functions, in addition to entropy coding quantized transform coefficients as described above. For example, entropy encoding unit 56 may construct header information for the block (e.g., macroblock, CU, or LCU), or video frame containing the block, with appropriate syntax elements for transmission in the encoded video bitstream. According to some coding standards, such syntax elements may include last significant coefficient position information for the block, e.g., a sequence of last significant coefficient flags represented using a context adaptive entropy (e.g., CABAC)-encoded value, as previously described. As also previously described, such last significant coefficient position information may consume a high percentage of the overall compressed video bitrate if coded inefficiently.

Accordingly, this disclosure provides techniques for efficiently coding last significant coefficient position information for a block of video data. In particular, when coding last significant coefficient position information for a block of video data by performing a context adaptive entropy coding process (e.g., a CABAC process) that includes applying a context model, this disclosure provides techniques for applying the context model based on at least three contexts, wherein the at least three contexts include, a size associated with the block, a position of a given one of the coefficients within the block according to the scanning order, and the scanning order.

As one example, video encoder 20 may be configured to encode certain blocks of video data (e.g., one or more macroblocks, or TUs of a CU). For example, as described above with reference to FIG. 1, video encoder 20 may be configured to code information that identifies a position of a last significant coefficient within a block of video data according to a scanning order associated with the block, wherein to code the information, video encoder 20 is configured to perform a context adaptive entropy coding process that includes video encoder 20 applying a context model based on at least three contexts, wherein the at least three contexts include a size associated with the block, a position of a given one of the coefficients within the block according to the scanning order, and the scanning order.

In this example, entropy encoding unit 56 of video encoder 20 may be configured to, for each of one or more coefficients associated with the block, starting with a first coefficient within the block according to the scanning order and ending with the last non-zero coefficient within the block according to the scanning order, and proceeding according to the scanning order, determine whether the coefficient is the last non-zero coefficient within the block according to the scanning order, and generate a last significant coefficient flag that indicates whether the coefficient is the last non-zero coefficient within the block according to the scanning order. Entropy encoding unit 56 may be further configured to arrange the last significant coefficient flags for the one or more coefficients into a sequence based on the scanning order, and encode the sequence by performing the context adaptive entropy coding process.

Entropy encoding unit 56 may be configured to determine an encoding context used to apply the context model to encode the sequence when performing the context adaptive entropy coding process. For example, as described above, the encoding context may include various characteristics of the block and of the particular last significant coefficient flag being encoded, such as, for example, a size associated with the block, a position of a coefficient corresponding to the flag within the block according to the scanning order, and the scanning order itself.

Entropy encoding unit 56 may be configured to use the encoding context to apply the context model to encode the sequence by performing the context adaptive entropy coding process. As a result, the encoded sequence may comprise a context adaptive entropy (e.g., CABAC)-encoded value that indicates the position of the last significant coefficient within the block according to the scanning order. For example, entropy encoding unit 56 may be configured to, for each last significant coefficient flag of the sequence being encoded, apply the context model based on the size and the scanning order associated with the block, and based on a position within the block, according to the scanning order, corresponding to the last significant coefficient flag. The context model may provide probability estimates for the last significant coefficient flag used to encode the flag as part of performing the context adaptive entropy coding process. The probability estimates may indicate the probability of the coefficient corresponding to the last significant coefficient flag being the last significant coefficient for the block.

Moreover, as also described above, entropy encoding unit 56 may be configured to update the context model based on the encoded last significant coefficient flags of the sequence to reflect which flag values are more or less likely to occur for the determined encoding context.

In any case, entropy encoding unit 56 may be configured to encode the block to include the encoded sequence indicating the last significant coefficient position information for the block. For example, entropy encoding unit 56 may be configured to output the encoded sequence into a bitstream. Because using the techniques described above may result in the encoded sequence comprising fewer bits than similar information coded using other methods, there may be a relative bit savings for a coded bitstream including the encoded sequence when using the techniques of this disclosure.

Inverse quantization unit 58 and inverse transform module 60 apply inverse quantization and inverse transformation, respectively, to reconstruct the residual block in the pixel domain, e.g., for later use as a reference block. Motion compensation unit 44 may calculate a reference block by adding the residual block to a predictive block of one of the frames of memory 64. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reconstructed video block for storage in memory 64. The reconstructed video block may be used by motion estimation unit 42 and motion compensation unit 44 as a reference block to inter-code a block in a subsequent video frame.

In this manner, video encoder 20 represents an example of a video coder configured to code information that identifies a position of a last non-zero coefficient within a block of video data according to a scanning order associated with the block, wherein to code the information, video encoder 20 is configured to perform a context adaptive entropy coding process that includes video encoder 20 applying a context model based on at least three contexts, wherein the at least three contexts include a size associated with the block, a position of a given one of the coefficients within the block according to the scanning order, and the scanning order.

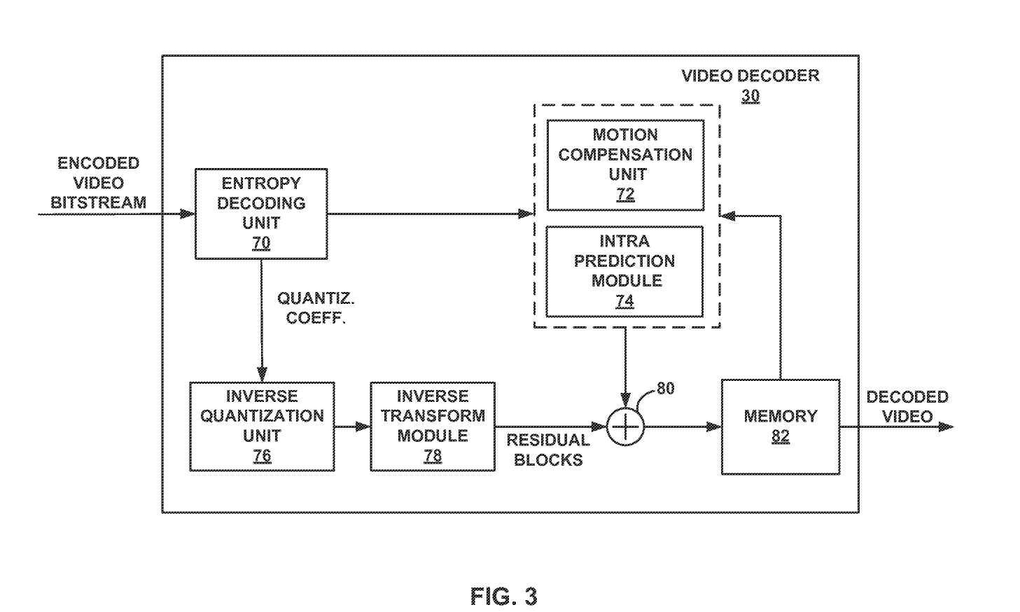

FIG. 3 is a block diagram that illustrates an example of a video decoder 30 that may implement techniques for decoding encoded information that identifies a position of a last significant coefficient within a block of video data according to a scanning order associated with the block, consistent with the techniques of this disclosure. In the example of FIG. 3, video decoder 30 includes an entropy decoding unit 70, motion compensation unit 72, intra-prediction module 74, inverse quantization unit 76, inverse transform module 78, memory 82 and summer 80. Video decoder 30 may, in some examples, perform a decoding pass generally reciprocal to the encoding pass described with respect to video encoder 20 (FIG. 2). Motion compensation unit 72 may generate prediction data based on motion vectors received from entropy decoding unit 70.

Video decoder 30 be configured to receive encoded video data (e.g., one or more macroblocks, or TUs of a CU) from video encoder 20. In accordance with the techniques of this disclosure, as one example, video decoder 30 may be configured to code information that identifies a position of a last significant coefficient within a block of video data according to a scanning order associated with the block, wherein to code the information, video decoder 30 is configured to perform a context adaptive entropy coding process that includes video decoder 30 applying a context model based on at least three contexts, wherein the at least three contexts include a size associated with the block, a position of a given one of the coefficients within the block according to the scanning order, and the scanning order.

In this example, entropy decoding unit 70 of video decoder 30 may be configured to decode a sequence of last significant coefficient flags for one or more coefficients associated with the block, starting with a first coefficient within the block according to the scanning order and ending with the last significant coefficient within the block according to the scanning order, and proceeding according to the scanning order, wherein each of the last significant coefficient flags indicates whether the respective coefficient is the last significant coefficient within the block according to the scanning order, by performing the context adaptive entropy coding process. Entropy decoding unit 70 may be further configured to, for each coefficient associated with the block, determine whether the coefficient is the last significant coefficient within the block according to the scanning order, based on the sequence. Entropy decoding unit 70 may be still further configured to decode the block based on the determinations, as described below.

As described above with reference to entropy encoding unit 56 of FIG. 2, the sequence (i.e., the “encoded” sequence) may comprise a context adaptive entropy (e.g., CABAC)-encoded value. As such, entropy decoding unit 70 may be further configured to determine a decoding context used to apply the context model to decode the sequence when performing the context adaptive entropy coding process. Entropy decoding unit 70 may be configured to determine the decoding context in a manner substantially similar to that of entropy encoding unit 56, as previously described. For example, the decoding context may include various characteristics of the block and of the particular last significant coefficient flag being decoded, such as, for example, a size associated with the block, a position of a coefficient corresponding to the flag within the block according to the scanning order, and the scanning order itself.

Entropy decoding unit 70 may be configured to use the decoding context to apply the context model to decode the sequence by performing the context adaptive entropy coding process. For example, entropy decoding unit 70 may be configured to, for each last significant coefficient flag of the sequence, apply the context model based on the size and the scanning order associated with the block (e.g., determined from other syntax information for the block), and based on a position within the block, according to the scanning order, corresponding to the last significant coefficient flag. The context model may provide probability estimates for the last significant coefficient flag used to decode the flag as part of performing the context adaptive entropy coding process. The probability estimates may indicate the probability of the coefficient corresponding to the last significant coefficient flag being the last significant coefficient for the block. As also described above, entropy decoding unit 70 may be configured to use the probability estimates to decode other last significant coefficient flags of the sequence as part of performing the context adaptive entropy coding process.

Moreover, entropy decoding unit 70 may be configured to update the context model based on the decoded last significant coefficient flags of the sequence to reflect which flag values are more or less likely to occur for the determined decoding context, e.g., to coordinate the context model with the context model used by entropy encoding unit 56 to encode the flags.

In any case, entropy decoding unit 70 may be configured to decode the block based on the determined last significant coefficient position information. Once again, because using the techniques described above may result in the encoded sequence comprising fewer bits than similar information coded using other methods, there may be a relative bit savings for a coded bitstream including the encoded sequence when using the techniques of this disclosure.

Motion compensation unit 72 may use motion vectors received in the bitstream to identify a prediction block in reference frames in memory 82. Intra-prediction module 74 may use intra-prediction modes received in the bitstream to form a prediction block from spatially adjacent blocks.

Intra-prediction module 74 may use an indication of an intra-prediction mode for the encoded block to intra-predict the encoded block, e.g., using pixels of neighboring, previously decoded blocks. For examples in which the block is inter-prediction mode encoded, motion compensation unit 72 may receive information defining a motion vector, in order to retrieve motion compensated prediction data for the encoded block. In any case, motion compensation unit 72 or infra-prediction module 74 may provide information defining a prediction block to summer 80.

Inverse quantization unit 76 inverse quantizes, i.e., de-quantizes, the quantized block coefficients provided in the bitstream and decoded by entropy decoding unit 70. The inverse quantization process may include a conventional process, e.g., as defined by the H.264 decoding standard or as performed by the HEVC Test Model. The inverse quantization process may also include use of a quantization parameter QP_{Y} calculated by video encoder 20 for each block to determine a degree of quantization and, likewise, a degree of inverse quantization that should be applied.

Inverse transform module 78 applies an inverse transform, e.g., an inverse DCT, an inverse integer transform, or a conceptually similar inverse transform process, to the transform coefficients in order to produce residual blocks in the pixel domain. Motion compensation unit 72 produces motion compensated blocks, possibly performing interpolation based on interpolation filters. Identifiers for interpolation filters to be used for motion estimation with sub-pixel precision may be included in the syntax elements. Motion compensation unit 72 may use interpolation filters as used by video encoder 20 during encoding of the video block to calculate interpolated values for sub-integer pixels of a reference block. Motion compensation unit 72 may determine the interpolation filters used by video encoder 20 according to received syntax information and use the interpolation filters to produce predictive blocks.

Motion compensation unit 72 uses some of the syntax information for the encoded block to determine sizes of blocks used to encode frame(s) of the encoded video sequence, partition information that describes how each block of a frame or slice of the encoded video sequence is partitioned, modes indicating how each partition is encoded, one or more reference frames (and reference frame lists) for each inter-encoded block or partition, and other information to decode the encoded video sequence. Intra-prediction module 74 may also use the syntax information for the encoded block to intra-predict the encoded block, e.g., using pixels of neighboring, previously decoded blocks, as described above.

Summer 80 sums the residual blocks with the corresponding prediction blocks generated by motion compensation unit 72 or intra-prediction module 74 to form decoded blocks. If desired, a deblocking filter may also be applied to filter the decoded blocks in order to remove blockiness artifacts. The decoded video blocks are then stored in memory 82, which provides reference blocks for subsequent motion compensation and also produces decoded video for presentation on a display device (such as display device 32 of FIG. 1).

In this manner, video decoder 30 represents an example of a video decoder configured to code information that identifies a position of a last non-zero coefficient within a block of video data according to a scanning order associated with the block, wherein to code the information, video decoder 30 is configured to perform a context adaptive entropy coding process that includes video decoder 30 applying a context model based on at least three contexts, wherein the at least three contexts include a size associated with the block, a position of a given one of the coefficients within the block according to the scanning order, and the scanning order.

FIGS. 4A-4C are conceptual diagrams that illustrate an example of a block of video data and corresponding significant coefficient position information and last significant coefficient position information. As shown in FIG. 4A, a block of video data, e.g., a macroblock, or a TU of a CU, may include quantized transform coefficients. For example, as shown in FIG. 4A, block 400 may include quantized transform coefficients generated using prediction, transform, and quantization techniques previously described. Assume, for this example, that block 400 has a size of 2N×2N, wherein N equals to two. Accordingly, block 400 has a size of 4×4, and includes sixteen quantized transform coefficients, as also shown in FIG. 4A. Assume further, that the scanning order associated with block 400 is the zig-zag scanning order, as shown in FIG. 5A described in greater detail below.

In this example, a last significant coefficient within block 400 according to the zig-zag scanning order is a quantized transform coefficient equal to “1,” located in position 406 within block 400. In other examples, as described above, a block may have a size that is smaller or larger than the size of block 400, and may include more or fewer quantized transform coefficients than block 400. In still other examples, the scanning order associated with block 400 may be a different scanning order, e.g., a horizontal scanning order, a vertical scanning order, a diagonal scanning order, or another scanning order.

FIG. 4B illustrates an example of significant coefficient flag data, i.e., significant coefficient flags represented in map, or block form, as previously described. In the example of FIG. 4B, block 402 may correspond to block 400 depicted in FIG. 4A. In other words, the significant coefficient flags of block 402 may correspond to the quantized transform coefficients of block 400. As shown in FIG. 43, the significant coefficient flags of block 402 that are equal to “1” correspond to significant coefficients of block 400. Similarly, the significant coefficient flags of block 402 that are equal to “0” correspond to zero, or non-significant coefficients of block 400.

In this example, a significant coefficient flag of block 402 corresponding to the last significant coefficient within block 400 according to the zig-zag scanning order is a significant coefficient flag equal to “1,” located in position 408 within block 402. In other examples, the values of significant coefficient flags used to indicate significant or non-significant coefficients may vary significant coefficient flags equal to “0” may correspond to significant coefficients, and significant coefficient flags equal to “1” may correspond to non-significant coefficients).

FIG. 4C illustrates an example of last significant coefficient flag data, i.e., last significant coefficient flags represented in map, or block form, as also previously described. In the example of FIG. 4C, block 404 may correspond to block 400 and block 402 depicted in FIG. 4A and FIG. 4B, respectively. In other words, the last significant coefficient flags of block 404 may correspond to the quantized transform coefficients of block 400, and to the significant coefficient flags of block 402.

As shown in FIG. 4C, the last significant coefficient flag of block 404 that is equal to “1,” located in position 410 within block 404, corresponds to a last significant coefficient of block 400, and to a last one of the significant coefficient flags of block 402 that are equal to “1,” according to the zig-zag scanning order. Similarly, the last significant coefficient flags of block 404 that are equal to “0” (i.e., all remaining last significant coefficient flags) correspond to zero, or non-significant coefficients of block 400, and to all significant coefficient flags of block 402 that are equal to “1” other than the last one of such significant coefficient flags according to the zig-zag scanning order.

The values of the last significant coefficient flags used to indicate a last significant coefficient according to a scanning order may vary (e.g., a last significant coefficient flag equal to “0” may correspond to a last significant coefficient according to the scanning order, and last significant coefficient flags equal to “1” may correspond to all remaining coefficients). In any case, the significant coefficient flags of block 402, and the last significant coefficient flags of block 404, may be collectively referred to as SM data for block 400.

As described above, last significant coefficient position information for the block may be indicated by serializing last significant coefficient flags for the block from a two-dimensional block representation, as depicted in block 404 shown in FIG. 4C, into a one-dimensional array, using a scanning order associated with the block. In the example of blocks 400-404 shown in FIGS. 4A-4C, again assuming the zig-zag scanning order, the last significant coefficient position information for block 400 may be indicated by serializing the last significant coefficient flags of block 404 into a one-dimensional array. That is, the last significant coefficient position information for block 400 may be indicated by generating a sequence of last significant coefficient flags of block 404 according to the zig-zag scanning order. In this example, the generated sequence may correspond to a value “000001,” representing the first 6 last significant coefficient flags of block 404 according to the zig-zag scanning order.

It should be noted that the generated sequence may contain last significant coefficient flags corresponding to a range of block positions within block 400, starting from a first block position in the zig-zag scanning order (i.e., the top left block position, sometimes referred to as the “DC” position) and ending with a block position corresponding to the last significant coefficient of block 400 according to the zig-zag scanning order (i.e., corresponding to the last significant coefficient flag equal to “1” of block 404). Accordingly, in this example, no last significant coefficient flags following the last significant coefficient flag equal to “1” according to the zig-zag scanning order are included in the sequence. Generally speaking, last significant coefficient flags following a last significant coefficient flag equal to “1” according to a scanning order associated with a block of video data may not be needed to indicate last significant coefficient position information for the block. As such, in some examples, these flags are omitted from the generated sequence of last significant coefficient flags used to indicate the information.

It should also be noted that, as described above, if the last significant coefficient is located within a last block position according to the scanning order (e.g., the bottom right block position), the generated sequence may not include a last significant coefficient flag corresponding to the last block position, because the position may be inferred to contain the last significant coefficient for the block. Accordingly, in this example, the generated sequence may correspond to a value “000000000000000,” wherein the last significant coefficient flag corresponding to the last block position is not included in the sequence, and is inferred to equal “1.”

In any case, as described above, the generated sequence of last significant coefficient flags may be coded using a context adaptive entropy coding process (e.g., a CABAC process), including applying a context model based on at least three contexts, wherein the at least three contexts include a size associated with the block, a position of a given one of the coefficients within the block according to the scanning order, and the scanning order. In other words, the contexts may be used to apply the context model to code the sequence. For example, for each last significant coefficient flag of the sequence being coded, the context model may be applied based on the size (e.g., 4×4) and the scanning order (e.g., a zig-zag scanning order) associated with the block, and based on a position within the block, according to the scanning order, corresponding to the last significant coefficient flag. That is, the context model may provide probability estimates for the last significant coefficient flag used to code the flag as part of performing the context adaptive entropy coding process. The probability estimates may indicate the probability of the coefficient corresponding to the last significant coefficient flag being the last significant coefficient for the block. Additionally, the probability estimates for the context model may be updated based on the coded last significant coefficient flag to reflect which last significant coefficient flag values (e.g., “0” or “1”) are more or less likely to occur given the contexts.

As a result of applying and updating the context model using the contexts (i.e., at least the scanning order associated with the block), the context model may contain accurate probability estimates, possibly enabling efficient coding, e.g., using a small number of bits to code the last significant coefficient position information for the block. In this manner, the last significant coefficient position information for the block coded by performing the context adaptive entropy coding process and using the contexts may comprise fewer bits than similar information coded using other methods, e.g., by performing a context adaptive entropy coding process and using a different context.

In this manner, video encoder 20 of FIG. 2 and/or video decoder 30 of FIG. 3 may be configured to code information that identifies a position of a last non-zero coefficient within a block of video data according to a scanning order associated with the block, wherein to code the information, video encoder 20 and/or video decoder 30 are configured to perform a context adaptive entropy coding process that includes video encoder 20 and/or video decoder 30 applying a context model based on at least three contexts, wherein the at least three contexts include a size associated with the block, a position of a given one of the coefficients within the block according to the scanning order, and the scanning order.

FIGS. 5A-5C are conceptual diagrams that illustrate examples of blocks of video data scanned using a zig-zag scanning order, a horizontal scanning order, and a vertical scanning order, respectively. As shown in FIGS. 5A-5C, an 8×8 block of video data, e.g., a macroblock, or a TU of a CU, may include sixty-four quantized transform coefficients in corresponding block positions, denoted with circles. For example, blocks 500-504 may each include sixty-four quantized transform coefficients generated using prediction, transform, and quantization techniques previously described, again, wherein each corresponding block position is denoted with a circle. Assume, for this example, that blocks 500-504 have a size of 2N×2N, wherein N equals to four. Accordingly, blocks 500-504 have a size of 8×8.

As shown in FIG. 5A, the scanning order associated with block 500 is the zig-zag scanning order. The zig-zag scanning order scans the quantized transform coefficients of block 500 in a diagonal manner as indicated by the arrows in FIG. 5A. Similarly, as shown in FIGS. 5B and 5C, the scanning orders associated with blocks 502 and 504 are the horizontal scanning order and the vertical scanning order, respectively. The horizontal scanning order scans the quantized transform coefficients of block 502 in a horizontal line-by-line, or “raster” manner, while the vertical scanning order scans the quantized transform coefficients of block 504 in a vertical line-by-line, or “rotated raster” manner, also as indicated by the arrows in FIGS. 5B and 5C.

In other examples, as described above, a block may have a size that is smaller larger than the size of blocks 500-504, and may include more or fewer quantized transform coefficients and corresponding block positions. In these examples, a scanning order associated with the block may scan the quantized transform coefficients of the block in a substantially similar manner as shown in the examples of 8×8 blocks 500-504 of FIGS. 5A-5C, e.g., a 4×4 block, or a 16×16 block, may be scanned following any of the scanning orders previously described.

In accordance with the techniques of this disclosure, information that identifies a position of a last significant coefficient (e.g., a sequence of last significant coefficient flags) within a block of video data (e.g., any one of blocks 500-504) according to a scanning order associated with the block (e.g., the zig-zag, horizontal, or vertical scanning order corresponding to blocks 500-504, respectively) may be coded by performing a context adaptive entropy coding process (e.g., a CABAC process) that includes applying a context model based on at least three contexts, wherein the at least three contexts include a size (e.g., 8×8) associated with the block, a position of a given one of the coefficients within the block according to the scanning order (e.g. a block position in the scanning order corresponding to the particular last significant coefficient flag in the sequence being coded), and the scanning order (e.g., the zig-zag, horizontal, or vertical scanning order corresponding to blocks 500-504, respectively).

As previously described, the techniques of this disclose may also apply with respect to a wide variety of other scanning orders, including a diagonal scanning order, scanning orders that are combinations of zigzag, horizontal, vertical, and/or diagonal scanning orders, as well as scanning orders that are partially zigzag, partially horizontal, partially vertical, and/or partially diagonal. In addition, the techniques of this disclosure may also consider a scanning order that is itself adaptive based on statistics associated with previously coded blocks of video data (e.g., blocks having the same block size or coding mode as the current block being coded). For example, an adaptive scanning order could be the scanning order associated with a block of video data, in some cases.

In this manner, video encoder 20 of FIG. 2 and/or video decoder 30 of FIG. 3 may be configured to code information that identifies a position of a last non-zero coefficient within a block of video data according to a scanning order associated with the block, wherein to code the information, video encoder 20 and/or video decoder 30 are configured to perform a context adaptive entropy coding process that includes video encoder 20 and/or video decoder 30 applying a context model based on at least three contexts, wherein the at least three contexts include a size associated with the block, a position of a given one of the coefficients within the block according to the scanning order, and the scanning order.

FIGS. 6A-6D are conceptual diagrams that illustrate examples of blocks of video data and corresponding context indices used for applying a context model. As described above, FIGS. 6A-6D show examples of how ctx values for last significant coefficient flags for a block of video data may be derived to code the flags using a size associated with the block, and corresponding coefficient positions within the block according to a scanning order associated with the block. FIGS. 6A and 6C show 4×4 blocks, where the derived ctx values are unique for each coefficient position within the respective block according to a scanning order associated with the block. For example, FIG. 6A shows a block where the ctx values, ranging from 0 to 15, vary for every block position according to a zig-zag scanning order. Similarly, FIG. 6C shows a block where the ctx values, also ranging from 0 to 15, vary for every block position according to a horizontal scanning order. FIG. 6B shows an 8×8 block, where the block positions located diagonally h respect to one another, as depicted in FIG. 6B, share a common ctx value ranging from 0 to 14. In this example, the ctx values vary for different ranges of block positions according to the zig-zag scanning order, that is, groups of block positions according to the zig-zag scanning order share a common ctx value between 0 and 14. Similarly, FIG. 6D shows another 8×8 block, where the block positions located in a particular region of the block defined according to a horizontal scanning order share a common ctx value between 0 and 8. Once again, in this example, the ctx values vary for different ranges of block positions according to the horizontal scanning order.

As one example, referring to FIG. 6C, the ctx derivation method shown in block 604 may be represented with the following relationship, wherein ctx is the context index, corresponding to a particular probability estimate contained within a context model as previously described, blocksize is a size associated with block 604 (i.e., 4×4, or simply “4”), as also previously described, and x and y are horizontal and vertical coordinates, respectively, within block 604, of a particular last significant coefficient flag for block 604 being coded.

ctx(x,y)=x+y*blocksize (1)

According to the relationship in (1), a size associated with a block, and x and y coordinates of a last significant coefficient flag for the block being coded may be used to derive a ctx value used to code the flag. That is, for a given set of x and y coordinates of a last significant coefficient flag for the block, the ctx value may be derived by summing the x coordinate value for the flag and the y coordinate value for the flag multiplied by the block size, e.g., ctx(0,0)=0, ctx(1,0)=1, and ctx(0,1)=4. As can be seen in this example, each block position within a 4×4 block according to the horizontal scanning order may have a unique ctx value. Blocksize may refer to the size of a CU, the size of a PU or the size of a TU.

As another example, referring to FIG. 6B, the ctx derivation method shown in block 602 may be represented with the following relationship, wherein ctx is once again the context index and x and y are the horizontal and vertical coordinates, respectively, within block 602, of a particular last significant coefficient flag for block 602 being coded.

ctx(x,y)=x+y (2)

According to the relationship in (2), x and y coordinates of a last significant coefficient flag for a block being coded may be used to derive a ctx value used to code the flag. That is, for a given set of x and y coordinates of a last significant coefficient flag for the block, the ctx value may be derived by summing the x and y coordinate values for the flag, e.g., ctx(1,1)=2, ctx(2,0)=2, and ctx(0,2)=2. As can be seen, regions of block positions within an 8×8 block according to the zig-zag scanning order, i.e., corresponding to diagonal lines 0-14, may share a common ctx value between 0 and 14.

It should be noted that, in the examples of FIGS. 6A-6D, in instances where a given block is larger than an 8×8 block a block position within the block may be mapped to a corresponding block position within an 8×8 block. Subsequently, any of the ctx value derivation methods for an 8×8 block previously described can be used to determine a ctx value for the block position within the larger block. As one example, 4 adjacent block positions within a 16×16 block may be mapped to a single block position within an 8×8 block for which a ctx value is determined using any of the above-described derivation methods, and share the ctx value. As another example, 16 adjacent positions within a 32×32 block may be mapped to a single position within an 8×8 block for which a ctx value is determined using any of the above-described derivation methods, and share the ctx value. In other examples, various other techniques may be used to derive ctx values for last significant coefficient flags for a given block of video data, each defined by a relationship between a size associated with the block, and corresponding coefficient positions within the block according to a scanning order associated with the block.

In accordance with the techniques of this disclosure, information that identifies a position of a last significant coefficient (e.g., a sequence of last significant coefficient flags) within a block of video data (e.g., any one of blocks 600-606) according to a scanning order associated with the block (e.g., the zig-zag or horizontal scanning orders corresponding to blocks 600-602, and 604-606, respectively, or other scanning orders) may be coded by performing a context adaptive entropy coding (e.g., a CABAC process) that includes applying a context model based on at least a size (e.g., 4×4, or 8×8) associated with the block, a position of a given one of the coefficients within the block according to the scanning order (e.g., a block position in the scanning order corresponding to the particular last significant coefficient flag of the sequence being coded), and the scanning order itself (e.g., the zig-zag or horizontal scanning orders corresponding to blocks 600-602, and 604-606, respectively, or other scanning orders). Specifically, a ctx value derived for each last significant coefficient flag of the sequence being coded determines probability estimates for the flag contained within the context model used to code the flag.

In particular, whereas the techniques described above with reference to FIGS. 6A-6D show examples of how ctx values for last significant coefficient flags for a block of video data may be derived to code the flags using a size associated with the block, and corresponding coefficient positions within the block according to a scanning order associated with the block, in accordance with the techniques of this disclosure, the ctx values may be derived based on at least a size associated with the block, a position of a given one of the coefficients within the block according to the scanning order, and the scanning order, as previously described.

In this manner, video encoder 20 of FIG. 2 and/or video decoder 30 of FIG. 3 may be configured to code information that identifies a position of a last non-zero coefficient within a block of video data according to a scanning order associated with the block, wherein to code the information, video encoder 20 and/or video decoder 30 are configured to perform a context adaptive entropy coding process that includes video encoder 20 and/or video decoder 30 applying a context model based on at least three contexts, wherein the at least three contexts include a size associated with the block, a position of a given one of the coefficients within the block according to the scanning order, and the scanning order.

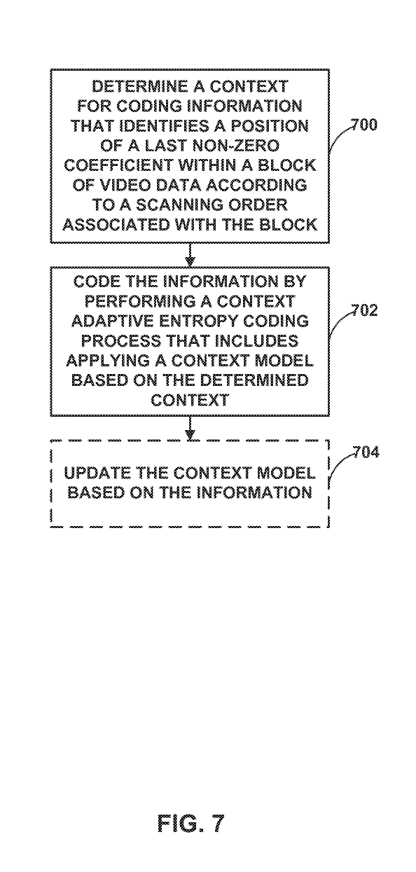

FIG. 7 is a flowchart that illustrates an example of a method of coding information that identifies a position of a last significant coefficient within a block of video data according to a scanning order associated with the block. The techniques of FIG. 7 may generally be performed by any processing unit or processor, whether implemented in hardware, software, firmware, or a combination thereof, and When implemented in software or firmware, corresponding hardware may be provided to execute instructions for the software or firmware. For purposes of example, the techniques of FIG. 7 are described with respect to video encoder 20 (FIGS. 1 and 2) and/or video decoder 30 (FIGS. 1 and 3), although it should be understood that other devices may be configured to perform similar techniques. Moreover, the steps illustrated in FIG. 7 may be performed in a different order or in parallel, and additional steps may be added and certain steps omitted, without departing from the techniques of this disclosure.

Initially, video encoder 20 and/or video decoder 30 may determine a context for coding information that identifies a position of a last non-zero coefficient within a block of video data according to a scanning order associated with the block (700). For example, the block may be a macroblock, or a TU of a CU. Furthermore, the scanning order associated with the block may be a zig-zag scanning order, a horizontal scanning order, a vertical scanning order, or another scanning order (e.g., a diagonal scanning order), as previously described. As also previously described, the context may be an encoding context in the case of video encoder 20, or a decoding context in the case of video decoder 30, in each case comprising at least three contexts, wherein the at least three contexts include a size associated with the block, a position of a given one of the coefficients within the block according to the scanning order, and the scanning order. Additionally, the information that identifies the position of the last non-zero coefficient within the block according to the scanning order associated with the block may be represented as a sequence of last significant coefficient flags, generated by serializing last significant coefficient flags for one or more coefficients of the block according to the scanning order, as also previously described.

Once the context is determined, the information may be encoded in the case of video encoder 20, or decoded in the case of video decoder 30, by performing a context adaptive entropy coding process (e.g., a CABAC process) that includes applying a context model based on the determined context, as described above. That is, video encoder 20 and/or video decoder 30 may code the information by performing a context adaptive entropy coding process that includes applying a context model based on the determined context (702). In examples where the information is represented as a sequence of last significant coefficient flags, as previously described, the context model may contain probability estimates that indicate the likelihood of a last significant coefficient flag being coded corresponding to the last significant coefficient for the block according to the scanning order (e.g., the last significant coefficient flag being equal to “0” or “1”). Using these probability estimates, in some cases represented as probability ranges (e.g., ranges between 0 and 1), video encoder 20 and/or video decoder 30 may code the last significant coefficient flag by performing the context adaptive entropy coding process.

More specifically, in the case of video encoder 20, the probability ranges contained within the context model may be used to encode the last significant coefficient flag with other last significant coefficient flags in the sequence, wherein each of the other flags also corresponds to an associated probability range contained within the context model. In particular, as one example, video encoder 20 may generate a context adaptive entropy-encoded value representing the entire sequence of last significant coefficient flags by successively narrowing an initial probability range valued between “0” and “1” for each flag in the sequence using the probability ranges contained within the context model corresponding to the flag. The resulting encoded value, corresponding to a probability range that is narrower than the initial probability range, may be used to represent the entire sequence.

Similarly, in the case of video decoder 30, the probability ranges contained within the context model may be used to decode the last significant coefficient flag from a received context adaptive entropy-encoded value representing the entire sequence of last significant coefficient flags, again wherein each of the other flags also corresponds to an associated probability range contained within the context model. In particular, video decoder 30 may generate the sequence from the received value by successively broadening a probability range corresponding to the value for each last significant coefficient flag in the sequence, once again using the probability ranges contained within the context model corresponding to the flag.

Video encoder 20 and/or video decoder 30 may further update the context model based on the information (704). For example, video encoder 20 and/or video decoder 30 may update the probability estimates contained within the context model based on whether the coded last significant coefficient flag corresponds to the last significant coefficient for the block. In other words, the probability estimates contained within the context model that indicate the likelihood of a last significant coefficient flag coded using the context model corresponding to a last significant coefficient for a block according to a scanning order associated with the block, as previously described, may be updated using the coded last significant coefficient flag. For example, wherein the probability estimates indicate the likelihood of a last significant coefficient flag coded using the context model being equal to “0” or “1,” the probability estimates may be updated based on whether the coded last significant coefficient flag equals “0” or “1.”

In this manner, the method of FIG. 7 represents an example of a method of coding coefficients associated with a block of video data during a video coding process, the method comprising coding information that identifies a position of a last non-zero coefficient within the block according to a scanning order associated with the block, wherein coding the information comprises performing a context adaptive entropy coding process that includes applying a context model based on at least three contexts, wherein the at least three contexts include a size associated with the block, a position of a given one of the coefficients within the block according to the scanning order, and the scanning order.

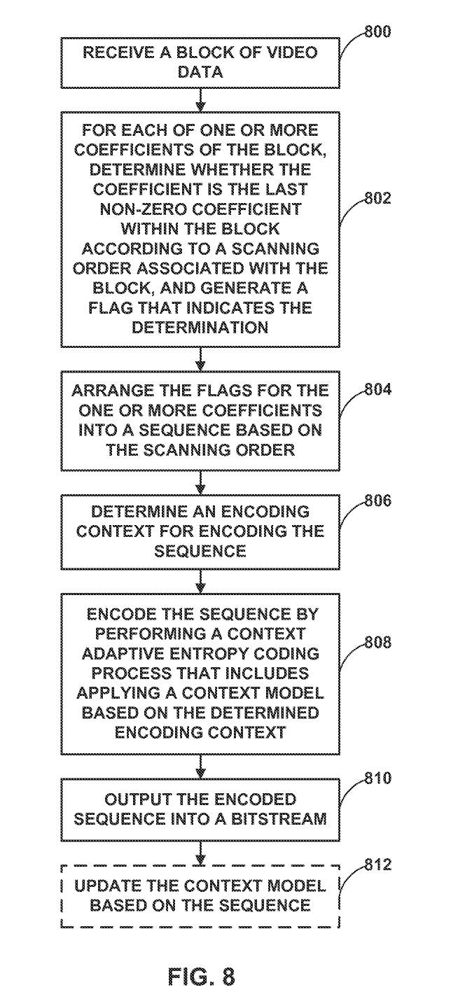

FIG. 8 is a flowchart that illustrates an example of a method of encoding information that identifies a position of a last significant coefficient within a block of video data according to a scanning order associated with the block. Once again, the techniques of FIG. 8 may generally be performed by any processing unit or processor, whether implemented in hardware, software, firmware, or a combination thereof, and when implemented in software or firmware, corresponding hardware may be provided to execute instructions for the software or firmware. For purposes of example, the techniques of FIG. 8 are described with respect to entropy encoding unit 56 (FIG. 2), although it should be understood that other devices may be configured to perform similar techniques. Moreover, the steps illustrated in FIG. 8 may be performed in a different order or in parallel, and additional steps may be added and certain steps omitted, without departing from the techniques of this disclosure.

Initially, entropy encoding unit 56 may receive a block of video data (800). For example, the block may be a macroblock, or a TU of a CU. Entropy encoding unit 56 may further encode information that identifies a position of a last non-zero coefficient within the block according to a scanning order associated with the block. For example, entropy encoding unit 56 may, for each of one or more coefficients associated with the block, starting with a first coefficient within the block according to the scanning order and ending with the last non-zero coefficient within the block according to the scanning order, and proceeding according to the scanning order, determine whether the coefficient is the last non-zero coefficient within the block according to the scanning order, and generate a last significant coefficient flag that indicates whether the coefficient is the last non-zero coefficient within the block according to the scanning order (802). Entropy encoding unit 56 may further arrange the last significant coefficient flags for the one or more coefficients into a sequence based on the scanning order (804). For example, entropy encoding unit 56 may arrange last significant coefficient flags for all coefficients in the scanning order excluding any coefficients following the last significant coefficient according to the scanning order. Entropy encoding unit 56 may further determine an encoding context for encoding the sequence (806). For example, the encoding context may comprise at least a size associated with the block, a position of a given one of the coefficients within the block according to the scanning order, and the scanning order. Entropy encoding unit 56 may further encode the sequence by performing the context adaptive entropy coding process (e.g., a CABAC process) that includes applying a context model based on the determined encoding context (808). For example, entropy encoding unit 56 may, for each last significant coefficient flag of the sequence, apply the context model based at least in part on a position within the block, according to the scanning order, corresponding to the last significant coefficient flag. Entropy encoding unit 56 may further output the encoded sequence into a bitstream (810). Finally, entropy encoding unit 56 may update the context model based on the sequence (812).

In this manner, the method of FIG. 8 represents an example of a method of coding coefficients associated with a block of video data during a video coding process, the method comprising coding information that identifies a position of a last non-zero coefficient within the block according to a scanning order associated with the block, wherein coding the information comprises performing a context adaptive entropy coding process that includes applying a context model based on at least three contexts, wherein the at least three contexts include a size associated with the block, a position of a given one of the coefficients within the block according to the scanning order, and the scanning order.

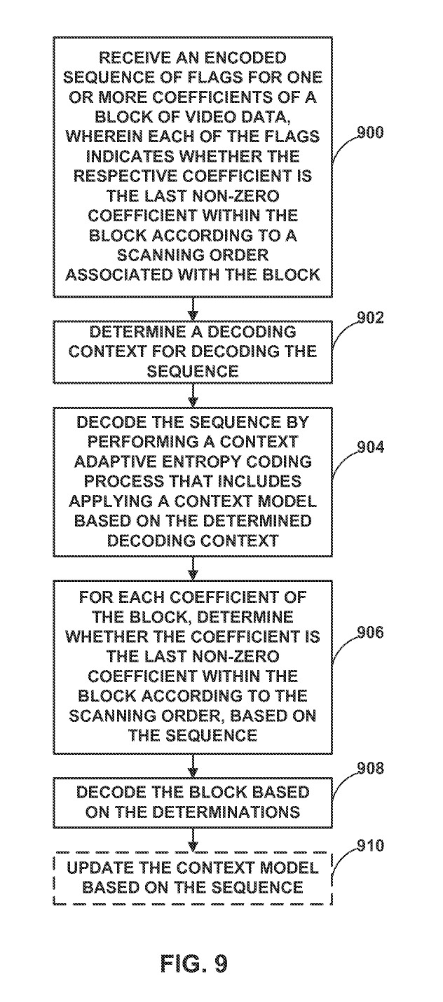

FIG. 9 is a flowchart that illustrates an example of a method of decoding encoded information that identifies a position of a last significant coefficient within a block of video data according to a scanning order associated with the block, Once again, the techniques of FIG. 9 may generally be performed by any processing unit or processor, whether implemented in hardware, software, firmware, or a combination thereof, and when implemented in software or firmware, corresponding hardware may be provided to execute instructions for the software or firmware. For purposes of example, the techniques of FIG. 9 are described with respect to entropy decoding unit 70 (FIG. 3), although it should be understood that other devices may be configured to perform similar techniques. Moreover, the steps illustrated in FIG. 9 may be performed in a different order or in parallel, and additional steps may be added and certain steps omitted, without departing from the techniques of this disclosure.

Initially, entropy decoding unit 70 may receive encoded video data. For example, the encoded video data may be for a block of video data, e.g., a macroblock, or a TU of a CU. Entropy decoding unit 70 may further decode information that identifies a position of a last non-zero coefficient within the block according to a scanning order associated with the block. For example, entropy decoding unit 70 may receive an encoded sequence of last significant coefficient flags for one or more coefficients associated with the block, starting with a first coefficient within the block according to the scanning order and ending with the last non-zero coefficient within the block according to the scanning order, and proceeding according to the scanning order, wherein each of the last significant coefficient flags indicates whether the respective coefficient is the last non-zero coefficient within the block according to the scanning order (900). The encoded sequence may comprise a context adaptive entropy (e.g., CABAC)-encoded value representing the sequence, as previously described. Entropy decoding unit 70 may further determine a decoding context for decoding the sequence (902). For example, as described above with reference to entropy encoding unit 56, the decoding context may comprise at least a size associated with the block, a position of a given one of the coefficients within the block according to the scanning order, and the scanning order. Entropy decoding unit 70 may further decode the sequence by performing a context adaptive entropy coding process (e.g., a CABAC process) that includes applying a context model based on the determined decoding context (904). For example, entropy decoding unit 70 may, for each last significant coefficient flag of the sequence, apply the context model based at least in part on a position within the block, according to the scanning order, corresponding to the last significant coefficient flag. As described above, for example, the sequence may comprise last significant coefficient flags for all coefficients in the scanning order excluding any coefficients following the last significant coefficient according to the scanning order. Entropy decoding unit 70 may further, for each coefficient associated with the block, determine whether the coefficient is the last non-zero coefficient within the block according to the scanning order, based on the sequence (906). Entropy decoding unit 70 may still further decode the block based on the determinations (908). Finally, entropy decoding unit 70 may update the context model based on the sequence (910).

In this manner, the method of FIG. 9 represents an example of a method of coding coefficients associated with a block of video data during a video coding process, the method comprising coding information that identifies a position of a last non-zero coefficient within the block according to a scanning order associated with the block, wherein coding the information comprises performing a context adaptive entropy coding process that includes applying a context model based on at least three contexts, wherein the at least three contexts include a size associated with the block, a position of a given one of the coefficients within the block according to the scanning order, and the scanning order.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of coding coefficients associated with a block of video data during a video coding process, the method comprising:
coding information that identifies a position of a last non-zero coefficient within the block according to a scanning order associated with the block,
wherein coding the information comprises performing a context adaptive entropy coding process that includes applying a context model based on at least three contexts, wherein the at least three contexts include:
a size associated with the block;
a position of a given one of the coefficients within the block according to the scanning order; and
the scanning order.

2. The method of claim 1, wherein coding comprises encoding, and wherein encoding the information that identifies the position of the last non-zero coefficient within the block according to the scanning order comprises:
for each of one or more coefficients associated with the block, starting with a first coefficient within the block according to the scanning order and ending with the last non-zero coefficient within the block according to the scanning order, and proceeding according to the scanning order, determining whether the coefficient is the last non-zero coefficient within the block according to the scanning order, and generating a last significant coefficient flag that indicates whether the coefficient is the last non-zero coefficient within the block according to the scanning order;
arranging the last significant coefficient flags for the one or more coefficients into a sequence based on the scanning order; and
encoding the sequence by performing the context adaptive entropy coding process.

3. The method of claim 2, wherein encoding the sequence by performing the context adaptive entropy coding process that includes applying the context model based on the position of the given one of the coefficients within the block according to the scanning order comprises:
for each last significant coefficient flag of the sequence, applying the context model based on a position within the block, according to the scanning order, corresponding to the last significant coefficient flag.

4. The method of claim 1, wherein coding comprises decoding, and wherein decoding the information that identifies the position of the last non-zero coefficient within the block according to the scanning order comprises:
decoding a sequence of last significant coefficient flags for one or more coefficients associated with the block, starting with a first coefficient within the block according to the scanning order and ending with the last non-zero coefficient within the block according to the scanning order, and proceeding according to the scanning order, wherein each of the last significant coefficient flags indicates whether the respective coefficient is the last non-zero coefficient within the block according to the scanning order, by performing the context adaptive entropy coding process; and
for each coefficient associated with the block, determining whether the coefficient is the last non-zero coefficient within the block according to the scanning order, based on the sequence.

5. The method of claim 4, wherein decoding the sequence by performing the context adaptive entropy coding process that includes applying the context model based on the position of the given one of the coefficients within the block according to the scanning order comprises:
for each last significant coefficient flag of the sequence, applying the context model based on a position within the block, according to the scanning order, corresponding to the last significant coefficient flag.

6. The method of claim 1, further comprising updating the context model based on the information that identifies the position of the last non-zero coefficient within the block according to the scanning order.

7. The method of claim 1, wherein the size associated with the block comprises a value corresponding to a number of the coefficients associated with the block.

8. The method of claim 1, wherein the scanning order comprises at least one of a zig-zag scanning order, a horizontal scanning order, a vertical scanning order, and a diagonal scanning order.

9. The method of claim 1, wherein the context adaptive entropy coding process comprises a context adaptive binary arithmetic coding (CABAC) process.

10. The method of claim 1, wherein the context adaptive entropy coding process comprises a probability interval partitioning entropy coding (PIPE) process.

11. An apparatus for coding coefficients associated with a block of video data during a video coding process, the apparatus comprising a video coder configured to:
code information that identifies a position of a last non-zero coefficient within the block according to a scanning order associated with the block,
wherein to code the information, the video coder is configured to perform a context adaptive entropy coding process that includes the video coder applying a context model based on at least three contexts, wherein the at least three contexts include:
a size associated with the block;
a position of a given one of the coefficients within the block according to the scanning order; and
the scanning order.

12. The apparatus of claim 11, wherein the video coder comprises an entropy encoding unit, and wherein to code the information that identifies the position of the last non-zero coefficient within the block according to the scanning order, the entropy encoding unit is configured to:
for each of one or more coefficients associated with the block, starting with a first coefficient within the block according to the scanning order and ending with the last non-zero coefficient within the block according to the scanning order, and proceeding according to the scanning order, determine whether the coefficient is the last non-zero coefficient within the block according to the scanning order, and generate a last significant coefficient flag that indicates whether the coefficient is the last non-zero coefficient within the block according to the scanning order;
arrange the last significant coefficient flags for the one or more coefficients into a sequence based on the scanning order; and
encode the sequence by performing the context adaptive entropy coding process.

13. The apparatus of claim 12, wherein to encode the sequence by performing the context adaptive entropy coding process that includes the entropy encoding unit applying the context model based on the position of the given one of the coefficients within the block according to the scanning order, the entropy encoding unit is configured to:
for each last significant coefficient flag of the sequence, apply the context model based on a position within the block, according to the scanning order, corresponding to the last significant coefficient flag.

14. The apparatus of claim 11, wherein the video coder comprises an entropy decoding unit, and wherein to code the information that identifies the position of the last non-zero coefficient within the block according to the scanning order, the entropy decoding unit is configured to:
decode a sequence of last significant coefficient flags for one or more coefficients associated with the block, starting with a first coefficient within the block according to the scanning order and ending with the last non-zero coefficient within the block according to the scanning order, and proceeding according to the scanning order, wherein each of the last significant coefficient flags indicates whether the respective coefficient is the last non-zero coefficient within the block according to the scanning order, by performing the context adaptive entropy coding process; and
for each coefficient associated with the block, determine whether the coefficient is the last non-zero coefficient within the block according to the scanning order, based on the sequence.

15. The apparatus of claim 14, wherein to decode the sequence by performing the context adaptive entropy coding process that includes applying the context model based on the position of the given one of the coefficients within the block according to the scanning order, the entropy decoding unit is configured to:
for each last significant coefficient flag of the sequence, apply the context model based on a position within the block, according to the scanning order, corresponding to the last significant coefficient flag.

16. The apparatus of claim 11, wherein the video coder is further configured to update the context model based on the information that identifies the position of the last non-zero coefficient within the block according to the scanning order.

17. The apparatus of claim 11, herein the size associated with the block comprises a value corresponding to a number of the coefficients associated with the block.

18. The apparatus of claim wherein the scanning order comprises at least one of a zig-zag scanning order, a horizontal scanning order, a vertical scanning order, and a diagonal scanning order.

19. The apparatus of claim 11, wherein the context adaptive entropy coding process comprises a context adaptive binary arithmetic coding (CABAC) process.

20. The apparatus of claim 11, wherein the context adaptive entropy coding process comprises a probability interval partitioning entropy coding (PIPE) process.

21. The apparatus of claim 11, wherein the apparatus comprises at least one of:
an integrated circuit;
a microprocessor; and
a wireless communication device that includes the video coder.

22. A device for coding coefficients associated with a block of video data during a video coding process, the device comprising:
means for coding information that identifies a position of a last non-zero coefficient within the block according to a scanning order associated with the block,
wherein the means for coding the information comprises means for performing a context adaptive entropy coding process that includes means for applying a context model based on at least three contexts, wherein the at least three contexts include:
a size associated with the block;
a position of a given one of the coefficients within the block according to the scanning order; and
the scanning order.

23. The device of claim 22, wherein coding comprises encoding, and wherein the means for encoding the information that identifies the position of the last non-zero coefficient within the block according to the scanning order comprises:
means for, for each of one or more coefficients associated with the block, starting with a first coefficient within the block according to the scanning order and ending with the last non-zero coefficient within the block according to the scanning order, and proceeding according to the scanning order, determining whether the coefficient is the last non-zero coefficient within the block according to the scanning order, and generating a last significant coefficient flag that indicates whether the coefficient is the last non-zero coefficient within the block according to the scanning order;
means for arranging the last significant coefficient flags for the one or more coefficients into a sequence based on the scanning order; and
means for encoding the sequence by performing the context adaptive entropy coding process.

24. The device of claim 23, wherein the means for encoding the sequence by performing the context adaptive entropy coding process that includes the means for applying the context model based on the position of the given one of the coefficients within the block according to the scanning order comprises:
means for, for each last significant coefficient flag of the sequence, applying the context model based on a position within the block, according to the scanning order, corresponding to the last significant coefficient flag.

25. The device of claim 22, wherein coding comprises decoding, and Wherein the means for decoding the information that identifies the position of the last non-zero coefficient within the block according to the scanning order comprises:
means for decoding a sequence of last significant coefficient flags for one or more coefficients associated with the block, starting with a first coefficient within the block according to the scanning order and ending with the last non-zero coefficient within the block according to the scanning order, and proceeding according to the scanning order, wherein each of the last significant coefficient flags indicates whether the respective coefficient is the last non-zero coefficient within the block according to the scanning order, by performing the context adaptive entropy coding process; and
means for, for each coefficient associated with the block, determining whether the coefficient is the last non-zero coefficient within the block according to the scanning order, based on the sequence.

26. The device of claim 25, wherein the means for decoding the sequence by performing the context adaptive entropy coding process that includes the means for applying the context model based on the position of the given one of the coefficients within the block comprises:
means for, for each last significant coefficient flag of the sequence, applying the context model based on a position within the block, according to the scanning order, corresponding to the last significant coefficient flag.

27. The device of claim 22, further comprising means for updating the context mod based on the information that identifies the position of the last non-zero coefficient within the block according to the scanning order.

28. The device of claim 22, wherein the size associated with the block comprises a value corresponding to a number of the coefficients associated with the block.

29. The device of claim 22, wherein the scanning order comprises at least one of a zig-zag scanning order, a horizontal scanning order, a vertical scanning order, and a diagonal scanning order.

30. The device of claim 22, wherein the context adaptive entropy coding process comprises a context adaptive binary arithmetic coding (CABAC) process.

31. The device of claim 22, wherein the context adaptive entropy coding process comprises a probability interval partitioning entropy coding (PIPE) process.

32. A computer-readable medium comprising instructions that, when executed, cause a processor to code coefficients associated with a block of video data during a video coding process, wherein the instructions cause the processor to:
code information that identifies a position of a last non-zero coefficient within the block according to a scanning order associated with the block,
wherein the instructions that cause the processor to code the information comprise instructions that cause the processor to perform a context adaptive entropy coding process that includes applying a context model based on at least three contexts, wherein the at least three contexts include:
a size associated with the block;
a position of a given one of the coefficients within the block according to the scanning order; and
the scanning order.

33. The computer-readable medium of claim 32, wherein coding comprises encoding, and wherein the instructions that cause the processor to encode the information that identifies the position of the last non-zero coefficient within the block according to the scanning order comprise instructions that cause the processor to:
for each of one or more coefficients associated with the block, starting with a first coefficient within the block according to the scanning order and ending with the last non-zero coefficient within the block according to the scanning order, and proceeding according to the scanning order, determine whether the coefficient is the last non-zero coefficient within the block according to the scanning order, and generate a last significant coefficient flag that indicates whether the coefficient is the last non-zero coefficient within the block according to the scanning order;
arrange the last significant coefficient flags for the one or more coefficients into a sequence based on the scanning order; and
encode the sequence by performing the context adaptive entropy coding process.

34. The computer-readable medium of claim 33, wherein the instructions that cause the processor to encode the sequence by performing the context adaptive entropy coding process that includes applying the context model based on the position of the given one of the coefficients within the block according to the scanning order comprise instructions that cause the processor to:
for each last significant coefficient flag of the sequence, apply the context model based on a position within the block, according to the scanning order, corresponding to the last significant coefficient flag.

35. The computer-readable medium of claim 32, wherein coding comprises decoding, and where the instructions that cause the processor to decode the information that identifies the position of the last non-zero coefficient within the block according to the scanning order comprise instructions that cause the processor to:
decode a sequence of last significant coefficient flags for one or more coefficients associated with the block, starting with a first coefficient within the block according to the scanning order and ending with the last non-zero coefficient within the block according to the scanning order, and proceeding according to the scanning order, wherein each of the last significant coefficient flags indicates whether the respective coefficient is the last non-zero coefficient within the block according to the scanning order, by performing the context adaptive entropy coding process; and
for each coefficient associated with the block, determine whether the coefficient is the last non-zero coefficient within the block according to the scanning order, based on the sequence.

36. The computer-readable medium of claim 35, wherein the instructions that cause the processor to decode the sequence by performing the context adaptive entropy coding process that includes applying the context model based on the position of the given one of the coefficients within the block according to the scanning order comprise instructions that cause the processor to:
for each last significant coefficient flag of the sequence, apply the context model based on a position within the block, according to the scanning order, corresponding to the last significant coefficient flag.

37. The computer-readable medium of claim 32, further comprising instructions that cause the processor to update the context model based on the information that identifies the position of the last non-zero coefficient within the block according to the scanning order.

38. The computer-readable medium of claim 32, wherein the size associated with the block comprises a value corresponding to a number of the coefficients associated with the block.

39. The computer-readable medium of claim 32, wherein the scanning order comprises at least one of a zig-zag scanning order, a horizontal scanning order, a vertical scanning order, and a diagonal scanning order.

40. The computer-readable medium of claim 32, wherein the context adaptive entropy coding process comprises a context adaptive binary arithmetic coding (CABAC) process.

41. The computer-readable medium of claim 32, wherein the context adaptive entropy coding process comprises a probability interval partitioning entropy coding (PIPE) process.
